(19) United States
(12) Patent Application Publication
(10) Pub. No.: US 2005/0050472 A1
(43) Pub. Date: Mar. 3, 2005

(54) Method and apparatus for storing and accessing URL links

(76) Inventors: Walter L. Faseler JR., Austin, TX (US); Paul A. Ressler, American Fork, UT (US); John Alan Welsh, Austin, TX (US)

Correspondence Address: Rick B. Yeager, 10805 Mellow Lane, Austin, TX, 78759, US

(21) Appl. No.: 10/650,872

(22) Filed: Aug. 28, 2003

(51) Int. Cl. G09G 5/00; G06F 17/30

(52) U.S. Cl. 715/734; 715/777; 715/738; 715/739; 715/713; 715/816; 715/826; 707/3

(57) ABSTRACT

Information access is organized in a tree structure providing preview and search capability. URL links are represented in the tree structure by a convenient name. The name is associated with a URL address and descriptive material. A user may preview the name, URL, and descriptive material before accessing the URL link. All fields may be searched to create filtered results. Portions of the tree structure may be displayed under each of a plurality of tabs. Names may be copied and moved between tabs or between directories within a tab. Names are represented at an appropriate level of detail within the tree structure. Sponsor advertising may be displayed in proximity to the tree structure display. URL links are to local files, applications, and remote files such as web pages and fttp file locations.

### FIELD OF INVENTION

The current invention relates to a computer-based functional advertising device and tool for organizing, searching, displaying, and sharing a computer desktop or handheld device presentation of links to Internet addresses, files and computer programs in a manner that permits sponsor advertising and the display of file contents, notes or other descriptive content in description panes.

### BACKGROUND OF THE PRESENT INVENTION

There is a need for an efficient means of categorizing, recalling, and accessing web links, programs and local files and databases, together with descriptive information to support specific tasks. At one level, a local computer file is addressed by the same general Uniform Resource Locator (“URL”) mechanism as an Internet file. For example, all are accessed by citing a specific, computer recognizable address. Computer users have access to large amounts of information including local files, local applications, and internet sites. There is also a practical need for gathering and display of notes or other helpful information with certain of the items used or visited by the computer user. The management of this information requires effective methods of storing and recalling both local files and internet files, and methods for quickly launching application programs or the organized collection of related resources. One use of such a representation is a single desktop system for consolidating Internet searches or running one or more local programs, together with associated files. A benefit of such a single desktop or handheld system is that a number of applications may be efficiently launched from the same site.

In prior art systems, a user might store local files in one or more local directories; use a bookmark in a favorites file to save a useful Internet site; and launch local programs from desktop icons, from a start programs menu, or from clicking on an executable file from a directory. Once a URL is listed as a favorite, the web site or web page can be accessed at a later time through an Internet browser such as AOL, Microsoft Internet Explorer or Netscape Navigator. The user typically accesses the favorites or bookmarks list, scrolls to identify the desired web site, and double clicks on the URL or file alias. By contrast, in the current invention, the Internet link is stored locally and can be accessed without first launching a web browser. This ability to access Internet links and local files or applications has usefulness in desktop, portable notebook, and handheld device applications.

### SUMMARY OF THE INVENTION

The current invention provides a novel way of presenting information in a manner that provides faster and convenient access to application programs, local files, and Internet files. The invention presents these programs and files in a common intuitive outline format that permits both standard and customized presentation. The files and associated information are maintained as lists that can easily be manipulated, copied, shared, transported, mailed, or downloaded.

This format provides an efficient means of content management for a group or association, which can provide a valuable service to its members by offering the outlines to its members. The members can then either use the outlines as presented, or further customize the information.

One business application of the current invention is for an organization to provide useful outline to its members or customers, and for the organization to therefore maintain visibility on user desktops through the display of the organization's icon. One or more specific information folders may also be provided to permit fast and efficient access to the organization's services or advertisers.

The invention provides faster access to application programs such as email, and typically opens directly to specific functional parts of the programs rather than to introductory screens. The QLynx application runs on top of other programs to permit a high level functional navigation through multiple applications.

In one embodiment, QLynx allows the user to enter item names, an optional URL, and an optional description. The URLs may be several lines of text characters to specify the actual address of the item, either local or internet. The item name may be a convenient abbreviation or alias of the actual URL address, or may be standalone information that is not associated with a URL address. In one embodiment, the descriptive pane can include full text of web site, or several pages of text. The text in the descriptive pane is searchable so that the user may enter a desired text string. In one embodiment, the system will return create and return a new list of links related to the search term. In some examples, the descriptive pane may be used for separate pages of a document, so that key pages may be searched and recalled individually.

Various embodiments of the invention include the maintenance and display of item names only, item names and a URL, item names and a description, and item names with a URL and a description. In some cases, such as a list of contacts or a first stage outline of a project, the item name alone carries sufficient information for the user, and a URL or description block are not required.

In other cases, it is desirable to have a name and a description. In these cases, the description is visible as the name is reviewed, and the combined information in the name and in the description is sufficient for the user. Examples of this type of information display include lists of content where all of the content may be displayed in the descriptive block such as checklists, reference materials, and pending legislation where the name is used for subject matter organization, and the description is used for actual portions of the legislation. This case is also appropriate in project management tools where the basic outline of a name section is expanded through materials added in the descriptive blocks associated with the names.

In other cases, such as some internet links, it is desirable to have a name and a URL, in these cases, the name or the organizational context of the name provides sufficient information for the user to decide to access the URL link.

In many other cases, it is useful to have all three types of information—the URL, the name, and descriptive material. In these examples, the user typically either needs to use an application program or to obtain more detailed information through the URL link. The name and the structure of how the name is presented relative to the QLynx session and project provides a context for the link, and the descriptive block provides some information relative to the link as well as a way to search information related to the link or to preview the link.

In one embodiment, up to 16 tabs are presented on a computing display device such as a handheld computing device or a monitor for a desktop computer. Each tab is selectable, and opens a scrollable page where URL links are typically presented in a nested outline form. Each tab represents a .qpf file, and is a project. The outline may be expanded or contracted at any level. The outline represents a partial tree view of information and links. The combination of multiple tabs and outline representation permits the efficient organization and presentation of large amounts of information, or content, such as described in the examples below. The information accessibility is further enhanced by the definition at each access point of a descriptive name for the link; the actual link to an Internet page or local file; and an optional scrollable information block which can be used to present descriptive material, a summary, or some portion of the actual content of the link. The combination of the descriptive title and the descriptive material allows the user to effectively preview the content of the actual link. In some cases, the user may obtain sufficient information from the preview without opening the link.

The organization of information facilitates the efficient review of a large number of potential links by a user. For instance, rather than clicking on a URL link in favorites, the user may “preview” the site by reviewing the descriptive block. That review opportunity allows the user to be more selective in which links are accessed. The access is also typically faster than through the favorites list on an Internet browser because the links content summary can be reviewed, and the link can be accessed, without launching a browser. Similarly, the content or a summary of the content of local files such as word processing files, spreadsheet files, pdf files, databases, imaged documents, sound and video files, emails and faxes can be reviewed without launching a particular application program. Thus the current invention permits large amounts of information to be organized, and the invention permits that information to be efficiently previewed and accessed.

These features provide an efficient “content management” function ability that is particularly useful to organizations such as associations, alumni groups, governmental agencies, publications, and web hosts. In one business model for the current invention, an organization sponsors the use of the tool for its members. The organization benefits by providing valuable content and management of that content for its members; and by the frequent display of its advertising logo.

Since members may use the current invention as a desktop management device and perform most computer tasks from the tool—such as accessing local files and programs, directly sending email without opening a mail tool, and accessing Internet links without first going through a browser, it is expected that in many cases the tool will become the preferred operating format for the user.

Another benefit of the current invention is the ability to organize and selectively display large amounts of information. The invention permits the concurrent access to multiple QLynx Project Files, where each Project File presents multiple tabs, and each tab presents an outline page of expandable files. Each file may present further level of file structures so that the user can quickly navigate to a particular desired link. The navigation capability is further enhanced by the combination of descriptive titles and the presentation of descriptive preview materials for a link. This structure permits a large number of links to be effectively organized in a useful and customizable manner.

In one embodiment, the current invention serves as a desktop billboard where a sponsor's advertising logo may be visible on a user's computer display. Since the content and content management of the current invention may be very useful to a user, the advertising logo may be visible on the display device for long periods of time.

One aspect of the current invention is the use of multiple trees to represent information and links to information. The invention supports multiple sessions where each session can have multiple projects. Each of these projects may be represented by a tree structure.

In various embodiments, the current invention provides a novel advertising medium, a novel display and organization of information, a project assistant for incrementally developing information related to a project, a structured search tool with preview capability, and a data resource and data management tool.

### DESCRIPTION OF FIGURES

FIG. 1 is a flow chart for prior art file access through a browser or application.

FIG. 2 is a flow chart for QLynx file access

FIG. 3 is a schematic showing the tab and tree structures of an embodiment

FIG. 4 is a sample initial screen for QLynx

FIG. 5A is a high level flow chart for a single session

FIG. 5B is a detailed flow chart for tab operations in the example of FIG. 5A

FIG. 6 represents multiple sessions

FIG. 7 represents operations for an active session

FIG. 8 shows a refresh sequence

FIG. 9 shows a recent file operation

FIG. 10 is a data structure diagram

FIG. 11 is an example of an add an item dialogue box

FIG. 12 is an example of accessing information by name field only

FIG. 13 is an example of accessing information by name field and URL

FIG. 14 is an example of accessing information by name field and description

FIG. 15 is an example of adding a URL link to the example of FIG. 14

FIG. 16 is an example of media links

FIG. 17 is an example illustrating multiple tabs

FIG. 18 is an example for advertising content

FIG. 19 is an example for copying and pasting folders and lists

FIG. 20 is an example of creating a filtered list

FIG. 21 is a desktop management example

FIG. 22 Example of Windows™ Manager

FIG. 23 is a monthly publication example showing content and advertising links

FIG. 24 is an example of an application directed at teenagers

FIG. 25A is an example of launching a video application

FIG. 25B is an example of searching and launching an audio application

FIG. 26 is an example of a website monitoring device for an intelligence agency

FIG. 27 is an example for a retired persons organization

FIG. 28 is an example for a local bar association

FIG. 29 is an example for a teachers organization

FIG. 30 is an example of license agreement content

FIG. 31 is an example of a listing of colleges and applications

FIG. 32 is an example of a patent search

FIG. 33 is a real estate example

FIG. 34 is an example of a projected use for a governmental agency.

FIG. 35 is an example of teachers notes and email generation

FIG. 36A is a Spanish language example for an oil company

FIG. 36B is a Spanish language example for an airline

FIG. 37 Example of Guide Content for Austin, Tex.

### DETAILED DESCRIPTION OF EMBODIMENT—Accessing a QLynx File

Prior Art—Internet File Access

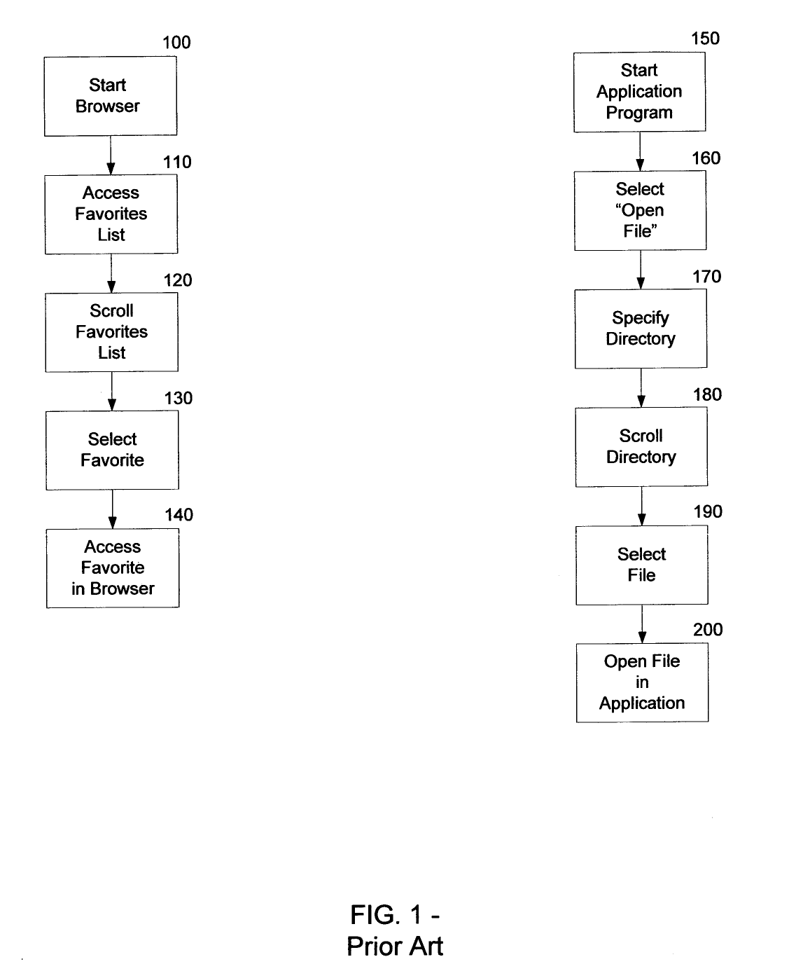

Referring now to FIG. 1, prior art internet file access typically requires starting a browser at step 100, accessing a favorites list at step 110, scrolling the favorites list at 120, selecting a file at step 130, and accessing the favorite file through the browser at step 140.

In a similar manner, an application program may be started at step 150. The operating system, such as Windows™ typically provides a File/Open function at step 160. The user specifies the directory or folder at step 170, scrolls the directory or folder at step 180, and selects a file at step 190. The file is opened into the application at step 200.

QLynx File Access

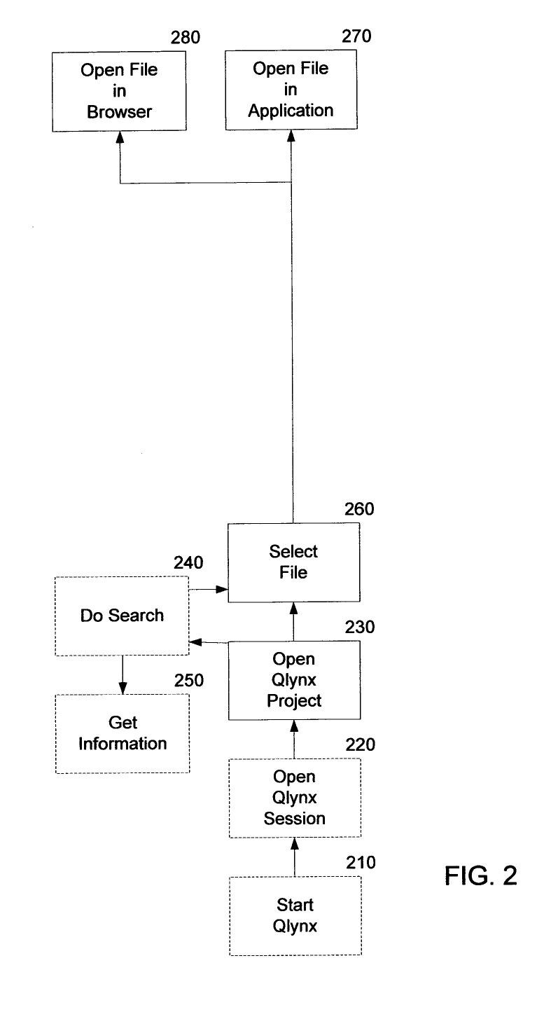

Referring now to FIG. 2, one aspect of the current invention is the ability to open files directly into a browser or other application. At step 210, QLynx is started. In many embodiments, QLynx will be running on top of other applications. In a multi-tasking environment, QLynx typically remains available for other access. At step 220, the user may open a different QLynx session. In many embodiments, the default QLynx session will be used. At step 230, the user selects a desired tab or project. In some examples, the file will be selected at step 260 from the project tab. In other examples, the user may conduct a search at step 240 on descriptive material name or URL to locate a desired file or location such as a web page or ftp file location. This search may be conducted on any desired portion of the outline tree representation. In some examples, the information associated with the name of the file is all that is required, and the user may access this information at step 250 without opening the file or an application. In other examples, the selected file will open into a browser at step 280 or into another application at step 270.

QLynx File Structure

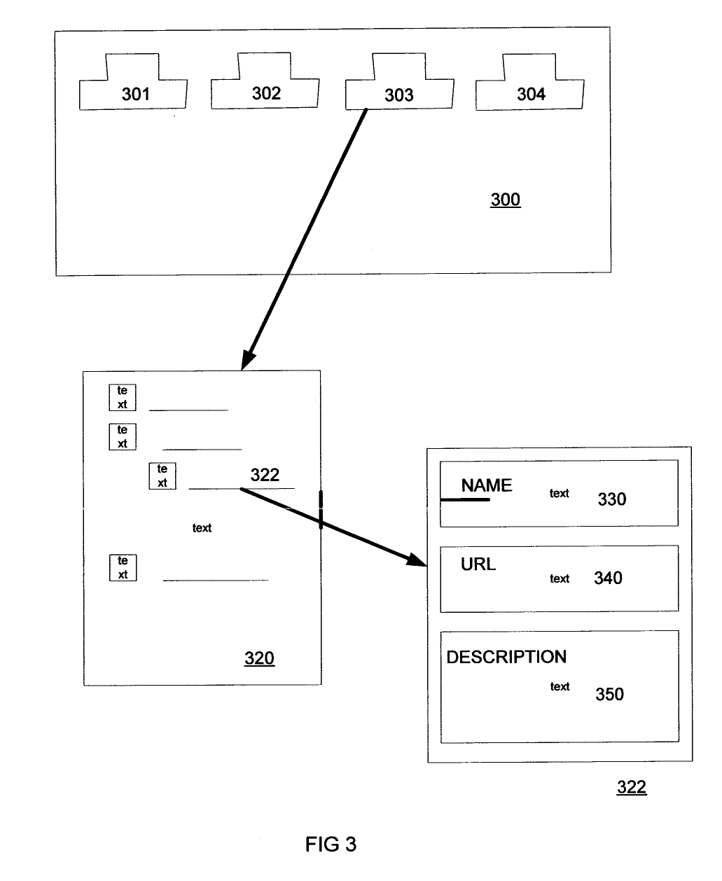

Referring now to FIG. 3, which is a schematic of the file structure of a QLynx embodiment, one embodiment of the invention includes a multiple tab structure 300, as illustrated by tabs 301, 302, 303, and 304. Each tab represents a tree structure, as illustrated by tab 304 and tree structure 320. As illustrated by item 322, each entry within a tree structure includes a name 330, an optional URL 340, and an optional description 350. The position of a name within a tab and within the tree structure associated with the tab provides a useful context for the link. As the user reviews these names, additional information may be obtained from the complete name or from the description.

In this embodiment, the representation format of multiple projects or tabs, tree structures within the tabs, and display of the full name, URL link, and description is common to each QLynx session. Thus the format permits a common structure and display of information so that in some cases, desired information is obtained by reviewing the name, and no URL or descriptive material is presented. In other cases, additional or related information is presented in the descriptive block, and no URL is presented. In other cases, the name and a URL is presented so that the user may access a link identified by the name. In other cases, all three types of information are presented—the name, the URL, and descriptive material, so that the user may search or preview the descriptive material in order to decide whether to access the link.

Detailed Description of Embodiment—Creating a QLynx File

Overall Organization

A QLynx Project File (“QPF”) is a particular session of QLynx, and is typically related to an area of interest for a user or sponsor organization. Since multiple sessions may appear on a desktop or display, it is often convenient to use different QPFs for different topics. Alternately, most or all files and applications for a user can be accessed from a single project file.

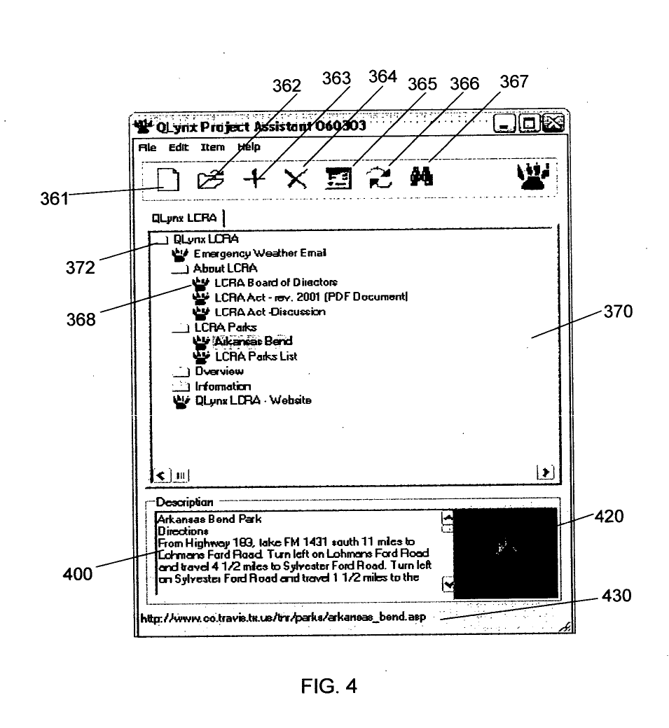

Referring now to FIG. 4, which is a sample screen for QLynx, the screen includes a tool bar 360, a file display 370, a description screen 400, an icon area 420, and a URL address 430. The tool bar includes icons for open a tab 361, open a file 362, add an item 363, delete an item 364, describe properties of an item 365, switch an item 366 and search 367.

In this example, the QPaw 368 is an icon which represents that the item has a URL link. The QPaw may be replaced by other icons such as a sponsor logo.

Each Project File may include multiple tabs, where a tab represents a project which is a tree structure of names. Each name may be associated with a link, a description, a link and a description, or neither a link nor a description. The sample screen shows a single tab 372. Additional tabs may be created by using the add item icon 363. For each tab, the file space by be organized as an outline of files. At each level of the link outline, the subsidiary links can be minimized or expanded.

Architecture

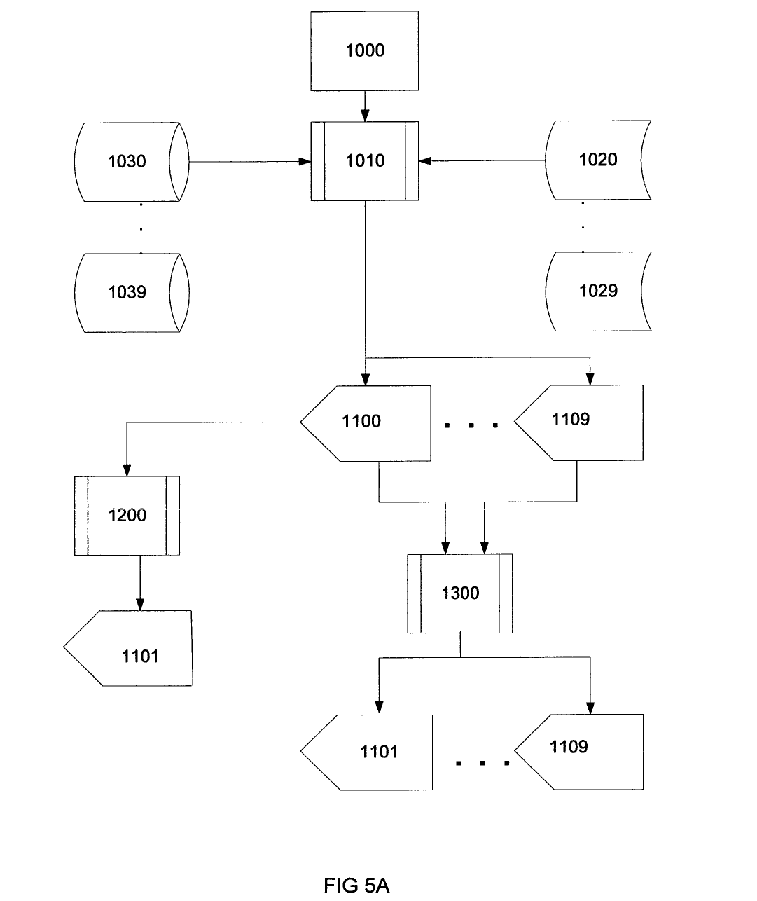

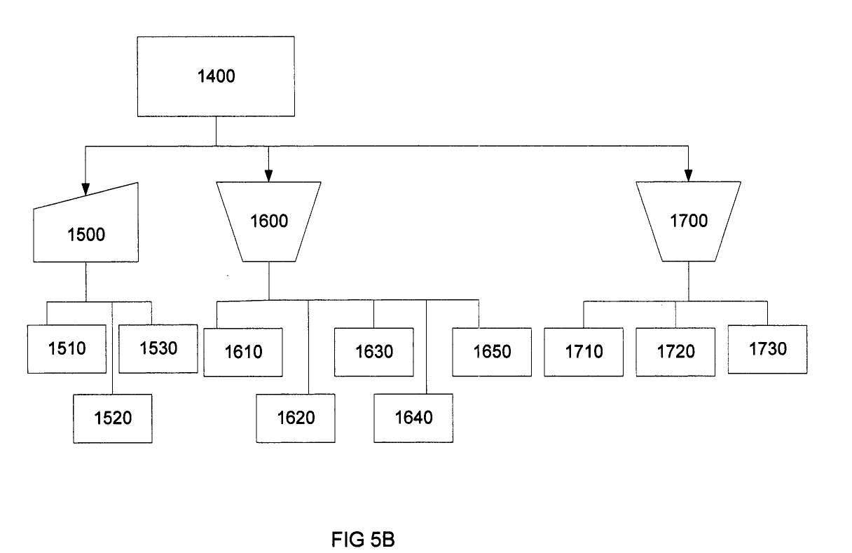

FIG. 5A is a high level flow chart for a single session of an embodiment of the current invention. At step 1000, a first session is initialized, and a tree generation screen 1010 is presented. The tree generation screen accesses either an existing stored file as indicated by stored file 1 1020 to stored file N 1029; or a manual input file as indicated by manual input file 1 1030 to manual input file N 1039. At step 1100, a particular tab is accessed as illustrated by tab.1 tree 1101 and tab.n tree 1109. For each tab, the user may perform an Intertab operation 1200, or an intratab operation 1300.

Referring now to FIG. 5B, tab operations 1400 include manual inputs 1500, manual item operations 1600, and manual file operations 1700. Manual inputs include add item 1510, delete item 1520, and select item 1530. Manual item operations include cut 1610, paste 1620, drag 1630, drop 1640, and sort 1650. Manual file operations include save 1710, save as 1720, and print 1730.

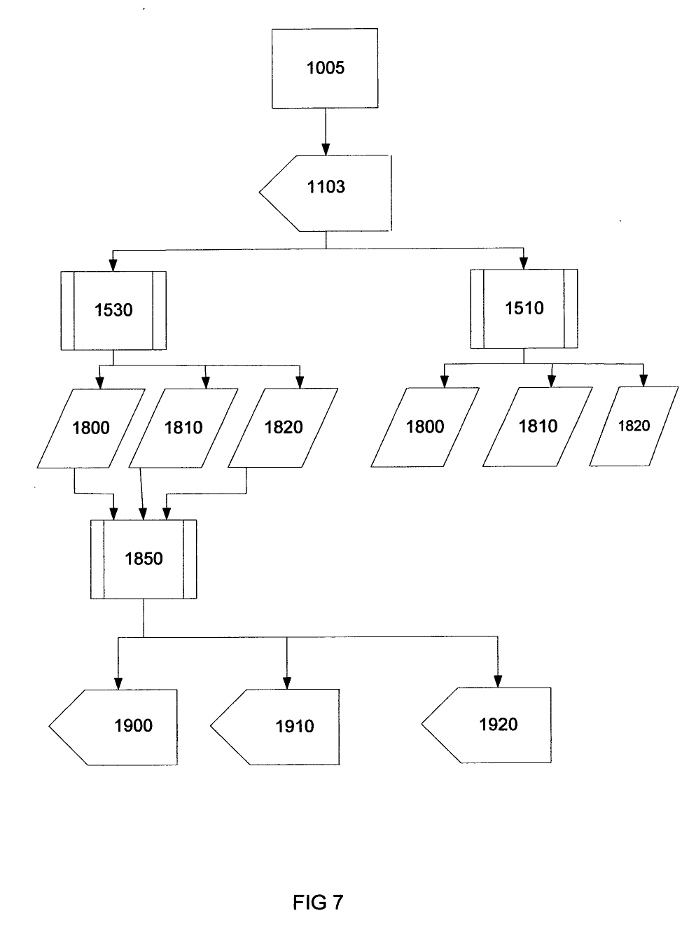

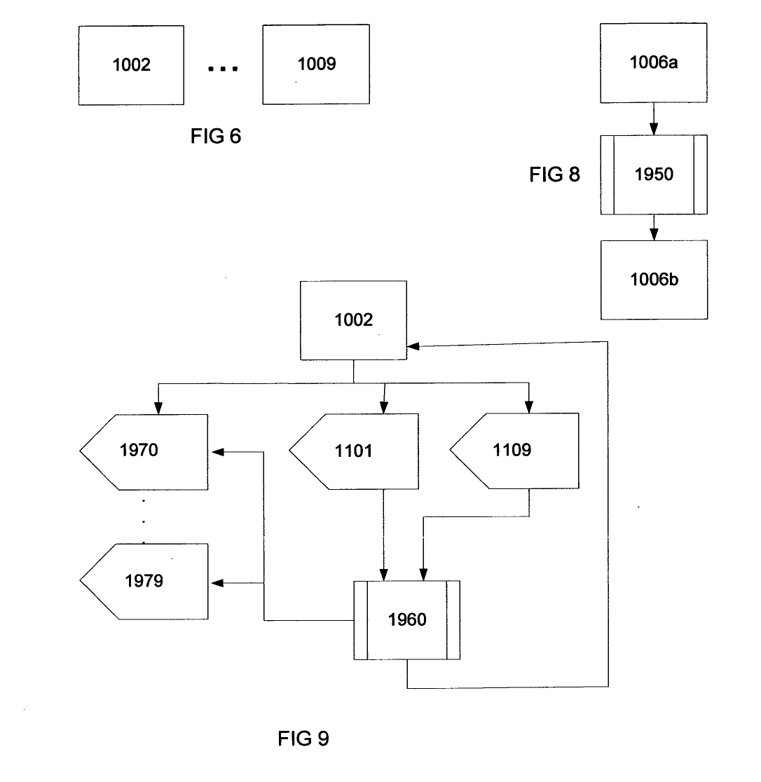

Referring now to FIG. 6, multiple sessions as indicated by session 1 1000 and session n 1009 may be accessed. Each of these sections is called a QLynx Project File.

Referring now to FIG. 7, for each active session x 1005, a particular tab, as indicated by tab.x tree 1103 may be accessed. For each tab, the user may select an item 1530 or add an item 1510. When an item is selected, its URL 1800, file 1810, or program 1820 are accessed, and the item becomes the active item 1850. An active item may activate an application or a file such as a URL browser 1900, a file editor 1910, or an application program 1920. When add an item 1510 is selected, the item URL 1800, file 1810, and application 1820, are recorded.

Referring now to FIG. 8, which is a refresh sequence, for a session 1006a, a refresh operation is initiated 1950, and the session 1006b is updated.

Referring now to FIG. 9, which is a recent file operation, a session 1002 may access a file such as file 1 1970 to file N 1979, or a tab such as tab tree such as tab 1 1101 to tab n 1109. The tab or file then becomes the recent file 1960, and the session 1002 continues.

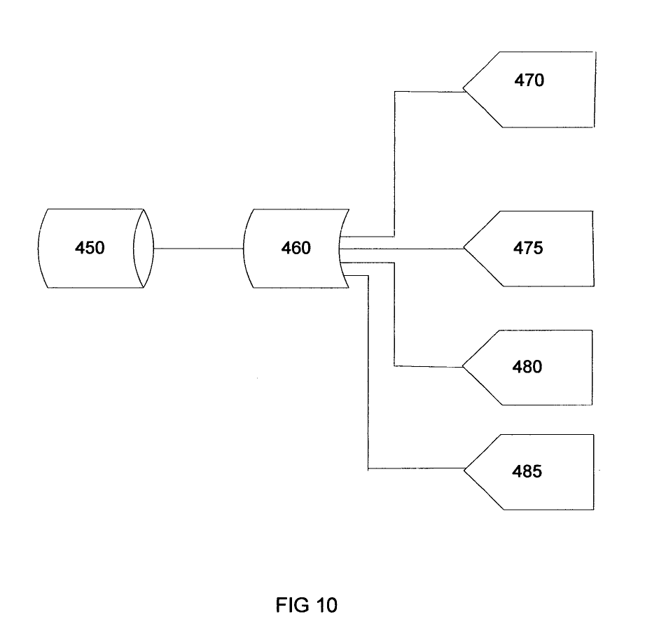

Referring now to FIG. 10 which is a schematic of the data layout and data flow, the database is contained within a .qpf 450 file. The .qpf file has data records 460 that can be items or folders. Data records contain data elements 470, 475, 480, 485. The data elements represent the Name 470, ID 475, Description 1221 480, and URL 485. If the data element ‘URL’ is blank then the data record is considered a folder rather than an item.

Building a Project File

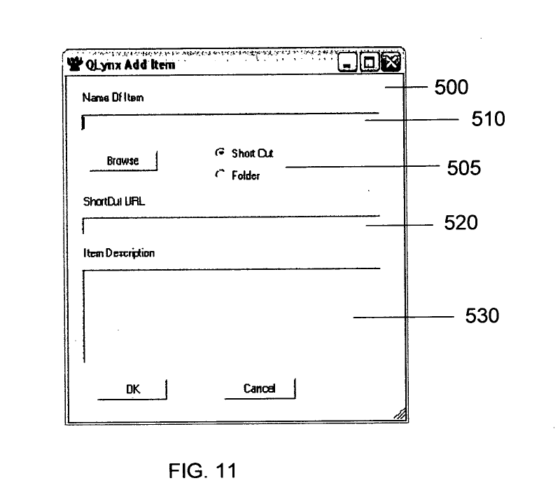

In operation, a desired tree structure is created where the higher levels of the tree may be expanded, and the lower levels typically represent links to captured Internet web pages, local files, local applications, notes and descriptions. One way to capture the links is illustrated in FIG. 11 which is an example add item dialog box. As each link is captured, a dialog box 500 permits the user to specify the name of the item 330 in a name field 510 and an item description 350 in an item description field 530. The user may select in a button menu 505 whether the item is a folder or a short cut. If the user selects short cut, then a URL 340 may be entered in a Shortcut URL field 520.

In some embodiments, each item may be assigned a unique key at the time that the item is created. This key may be used to differentiate items, such as during a search.

An internet link may be captured by several methods including typing the link address directly in the field provided, pasting the link address into the field from any other location such as a file or browser address block, or copying a shortcut or means of grasping the information in the Windows “copy” mode. The typical structure of an internet link may be its simple website address (http://www.website.com) or a very complex search structure: (http://www.google.com/url?q=http://www.1shoppingcart.com/app/adtrack.asp %3FAdID %3D34278&sa=1&ai=AnVwGuUf9-E87kUoiUQboxqrAye6QR3_y64NwWrgABUpTAAO1DEwABgpF&num=1)

A local file is captured by properly inserting its full path name into the field provided. A typical entry would be c:\word processor\wordprocessor.exe file or
c:\working files\word processor text file.type. These files are opened in their native application if the file type is associated with the program in the Windows environment. Files with an *.exe extension open the program identified.

Local entries may be captured or inserted into QLynx by typing or by selecting the item in the browse window, which opens standard Windows Files dialogs. The Description field is intended for more than a mere simple description; in one embodiment, it has a capacity of 32,000 characters, or about 10 word processing pages, and about 2000 database records. The name field and description field may be multilingual—from universal languages such as English, Spanish and French to Arabic, Thai, Hebrew, Russian, Greek and any other language characters supported by the Windows Environment. The name and description fields may be searched in a variety of languages.

Manipulating a Project File or Library

The links in a Project File or Library may be filtered by searching and sorting the name or description. The Project File representation tree structure may be modified by a cut and paste operation on particular links and folders, and links may be moved in that manner from one tabbed project to another. Cut, copy, paste operations may also be applied to a link or to a combination of links in a partial tree structure.

User access to particular links is facilitated by the use of multiple sessions, multiple tabs (project files) within the QLynx Interface, and an outline form within each tab. This organization of links permits the user to represent and effectively manage large numbers of links. The organization and presentation of the links may be manipulated from the user display with typical operations as described above.

Accessing the links

The combination of the representation of the links through libraries, tabs or projects, and outline form; the direct access of links to specific web pages, local files, and applications; and the preview features of the links assist the user in efficient access to information.

Once a link is selected for access, a specific web page can be directly accessed, in effect, without launching the browser by going directly to the link. Because this function works directly on the link, regardless of its level from the “home page” of the website, this process avoids a typically navigation through cascading menus or link trails. In a Windows environment, local programs are accessed through menus or desktop icons. In the current invention, local programs may be accessed from the same outline form as other files and Internet pages. Thus, a single representation is used for all types of information and application program access.

Detailed Description of Embodiment—Access by Name, Link, and Description

QLynx allows the user to enter item names, a URL or null URL such as a period, and an optional description. Some examples use only the name, some examples use the name and URL, some examples use the name and the description, and some examples use the name, URL and description. In this way, an outline is created which can be accessed and expanded as the user's project evolves.

### EXAMPLE

### Accessing Name Only

In this embodiment, only the name is entered or displayed. The item name may be a convenient abbreviation or alias of the actual URL address, or may be standalone information that is not associated with a URL address.

An example of using only a name is a list of contacts where all required information is presented in the name block. The contacts may be presented alphabetically, by functional group, or by any desired arrangement.

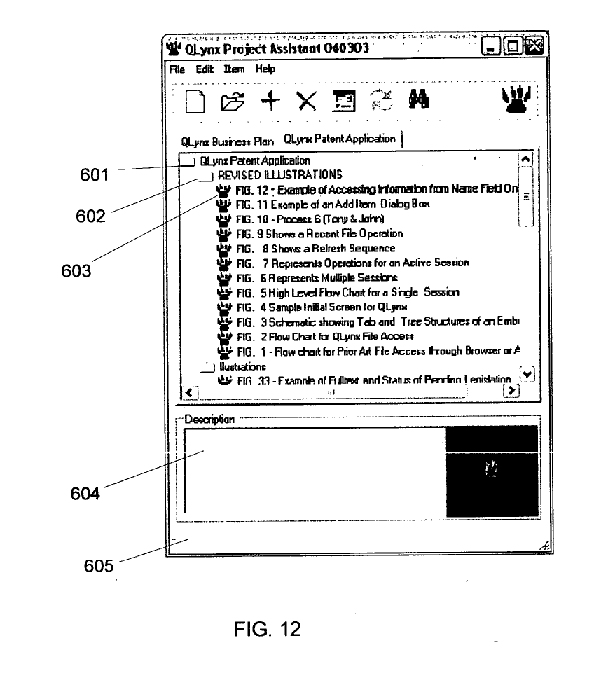

Referring now to FIG. 12, another example of using only a name is a template for the first step of a project assistant. In this example, the parts of a patent application are outlined. The main tab 601 is for the Qlynx patent application. A folder 602 is provided for a list of illustrations. One of the illustrations is “FIG. 12—Example of accessing information from name field only” 603. In this example, the title is sufficiently descriptive to indicate what illustration is required. If additional information were required, then it could be entered in the Description field 604. In this case, the URL address is null as indicated by the “..” in the URL field 605.

In this example, an early step in developing a large project is to provide a high level outline of tasks. Each of the high level tasks is organized in an outline form and presented as a task name. At subsequent steps of the project, as discussed below, additional information and links are recorded. This type of example includes proposal development and project development, such as for developing content for an association. The arrangement of names serves as a template for developing customized content for the association.

### EXAMPLE

### Accessing Name and URL

The URLs may be a simple identifier or several lines of text characters to specify the actual address of the item, either local or internet.

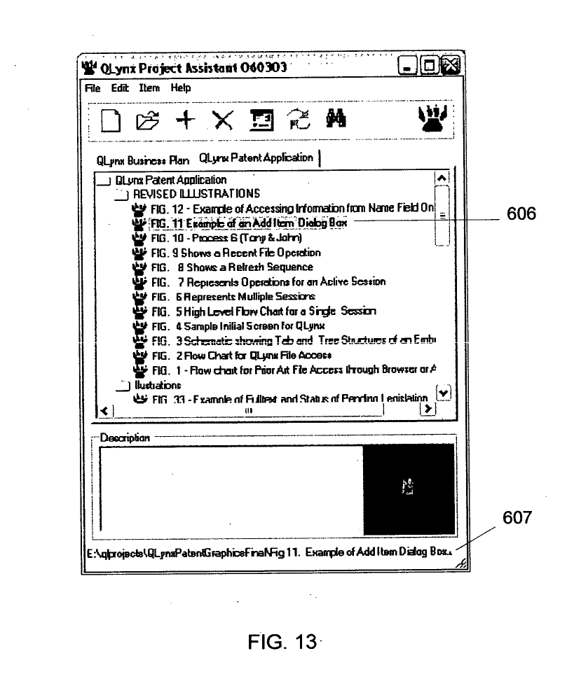

Referring now to FIG. 13, the example of FIG. 12 can be expanded for some or all items. For instance, an item 606 for “FIG. 11” now has a URL address 607 for the location of the illustration.

Another example of using the name and the URL without information in the descriptive block includes the internet links to various search engines of the world. Other examples include links to files where the name indicates the nature of the file; launching applications; and retrieving particular faxes or emails. Generally, the name and URL information is the fastest way of “building” the project file—descriptive material is added as necessary and/or desirable for more intensive use.

The URL may be used to save searches which may be several hundred characters. An additional URL can be inserted into the URL, such as emails which launch other functions.

In one example, an emergency weather notification system can send email to all designated recipients in the event of bad weather. Similarly, a Board of Directors or other group may be designated so that an email may be sent to the entire group.

### EXAMPLE

### Accessing Name and Description

In one embodiment, the descriptive pane can include full text of web site, or about 10 pages of text, or about 32,000 characters. The text in the descriptive pane is searchable so that the user may enter a desired text string. In one embodiment, the system will return create and return a new list of links related to the search term.

In this embodiment, the name and descriptive block are used, but the URL is typically not used. One example is a list of pending legislation, where the name is used for subject matter organization, and the description is used for actual portions of the legislation.

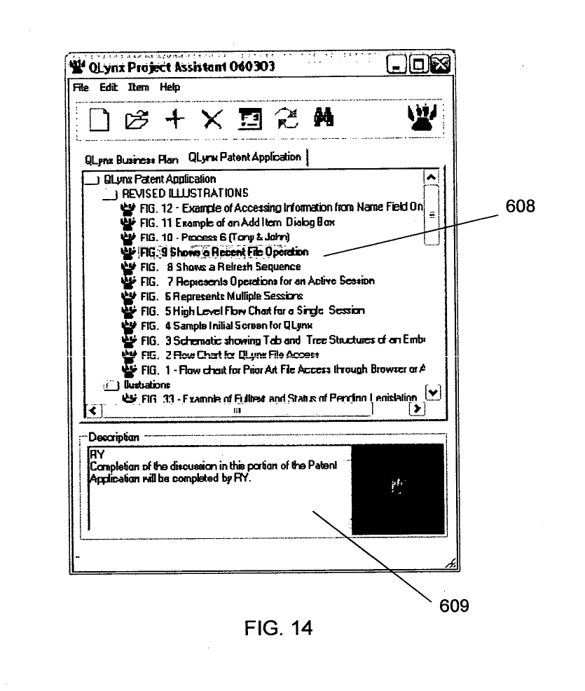

Referring now to FIG. 14 an item 608 for “FIG. 9” now has a status notation in the Description field 609.

Another example is a second step in project development. After a name only outline is developed, the user may begin to incorporate descriptive material associated with some of the names.

Other examples include checklists, maintenance of time records, and phone logs. In general, any information that a user might save from somewhere else can be organized in a way that it can be accessed faster.

In one embodiment, the descriptive block preserves the rough format of spreadsheets. For example, the descriptive field may hold about 2000 database records from a 4 column database, and the records are presented in a manner that is similar to the spreadsheet layout.

### EXAMPLE

### Accessing Name, Description, and URL

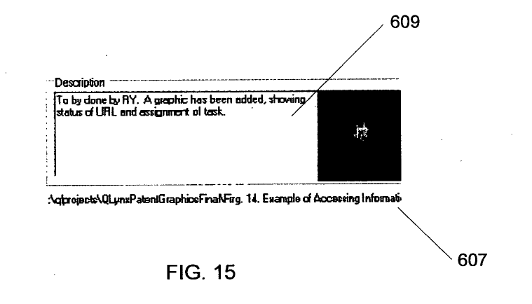

In this mode, the user may inspect the name and the description block before electing to access a URL link. This utility supports searching and previewing as well as the organization and display of useful content. For example, the information of FIG. 14 can be enhanced by including a URL for more complete or supplemental information as illustrated in FIG. 15 where a URL 607 has been added, or to directly access a document.

Detailed Decription of Embodiment—Examples of Use

The invention supports a wide range of uses as illustrated by the partial listing of examples described below. Some types of uses include indexing the internet or portions of the internet; a previewing tool for examining content without opening a file or accessing a link; an operating tool for tablet computers, notebook computers, and handheld devices; a sponsor advertising tool, an association content tool, an organization of functional content, and a project assistant.

As described more fully below, the invention may be employed in a wide range of subject areas on a variety of devices. The concise library, tab, outline representation of links coupled with the preview capability, makes the system appropriate for devices with limited display areas such as handheld devices and notebook computers. This condensed presentation of material is also useful for conventional desktop computers.

Some embodiments of the tool are relatively passive presentations of content, such as provided through associations and specific content such as multi-media books. In many cases, this content may be modified by the user, but the general structure of the content may be relatively stable. This organized presentation of useful content may be in the form of privately labeled software for organizations.

In other embodiments, the tool becomes a Project Assistant for organizing information from a bare template or even a blank library. In these types of applications, the user may be conducting an Internet research project, or simply organizing materials from a local computer.

These applications are examples of information organizers, database organizers, or desktop organizers.

The ability of QLynx to display all of its items in a tree-view is extremely useful in a PC desktop device embodiment, as well as embodiments for tablet computers and handheld devices such as pocket PC's and cell phones.

One aspect of the invention is its function as an extensible directory. A directory may be created and subsequently be annotated, modified, and searched. Annotations include names and description fields. Modifications include adding subdirectories and copying or moving items to another directory. Searching may include the creation of new search results which may be further annotated, modified, or searched.

### EXAMPLE

### Indexing

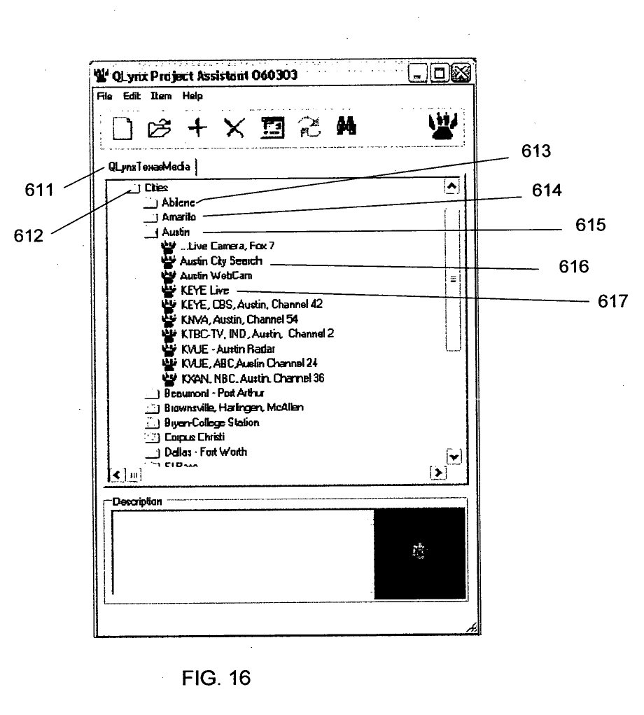

FIG. 16 shows an example project for media. The first level tab 611 has a descriptive name “QlynxTexasMedia”. A “Cities” folder 612 includes folders for a number of cities which are presented alphabetically in this example, including Abilene 613, Amarillo 614, and Austin 615. The Austin folder 615 has been expanded to show links including Austin City Search 616 and KEYE Live 617. Links may be further grouped by newspaper and media, television and cable news, government sites, foreign sites, etc. The user may click on a folder such as newspapers and media and access though the QLynx paw icon to AP wire services and other sources such as the New York Times, News Week, Time Magazine, USA Today, etc. This representation permits rapid access to the actual content portions of a variety of media sources.

In one embodiment, the invention permits faster access to filtered links. Because the capacity in size of QLynx Project Files permits the luxury of identifying the means of indexing the Internet's 17 million pages (by creation of multiple tabbed projects), a search inside a category is instantaneous and there is no search delay—select the search, click on the link, and delivery is with the rapidity of the users dial up, cable, or DSL service.

### EXAMPLE

### Multiple Tabs

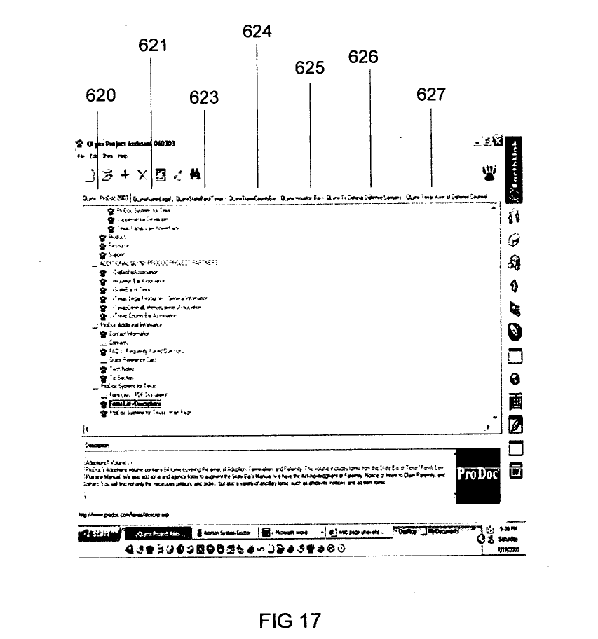

Referring now to FIG. 17, which demonstrates the nesting of tabs 620-627 in an example application. Other numbers of tabs can be used, and a 16 tab limitation is typically appropriate based upon practical limits to a conventional computer display device.

The invention supports more efficient links to existing user or customer content. One aspect of QLynx is the ability to efficiently direct a user to specific locations including programs, files, and websites. Prior art navigation is often limited to the Windows Explorer environment, marking of favorites, and cumbersome navigation of web pages through connected links. In many cases, the user has to backwardly navigate through links to go around them.

QLynx—with its folder structure and multiple sessions or tabbed projects, permits a “flatter” identification of known links—to directly progress to the location rather than navigating to reach it.

### EXAMPLE

### Previewing and Searching

In one embodiment, QLynx provides both a descriptive name field that provides some information about the nature or content of a link, and a descriptive field which can include a substantial amount of actual content or a summary of the link. By displaying the name and the description fields before accessing a particular link, QLynx provides a previewing capability so that a user can be more selective on what links are accessed.

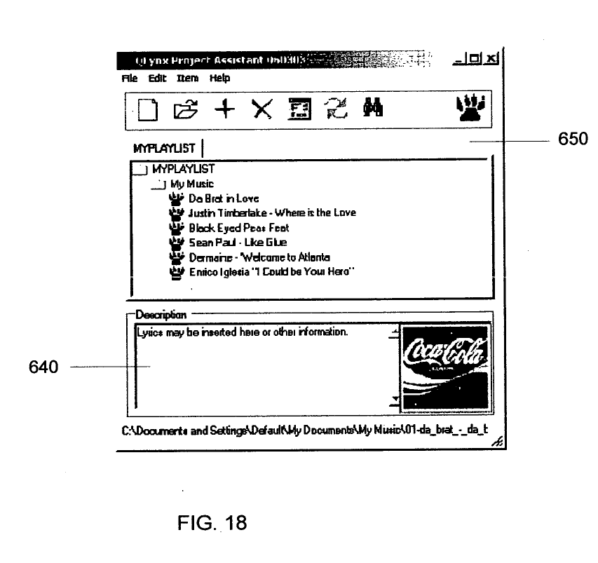

Referring now to FIG. 18, in one example, QLynx may be utilized for a preview of advertising content through its Descriptions Pane 640 of the General Display 650. In this example, a portion or all of the lyrics of a selected song may be displayed, or the display may also include advertising.

In another example, a magazine may permit any or all of its advertisers to be listed and to display the exact content of the advertisements in the particular issue of the magazine. The concept expands further with a virtually unlimited possibility of other textual content in that pane. Graphic content may be displayed directly by addressing its physical location—without accompanying text or download times of entire web pages. For instance, a single picture may be addressed as c:\picture.jpg or http://website.com/picture.jpg. This ability limits delays to the extent of the size of the image displayed, where text displays will be displayed simultaneously with the item in the Project File.

QLynx can display the contents of any file whose native application permits the “selection” of text within it. That is, PDF files, spreadsheets, databases, word processing documents, web pages, software code, foreign language text, email, and the like are all displayable, searchable, and selectable through QLynx.

Any character in the descriptive block is searchable. In one embodiment, 18 levels of embedded folders may be displayed in a manner that still leaves room for text for the name to be displayed.

QLynx has the ability to display and search automatically all characters in languages which are supported in the Windows environment, including “basic” foreign languages such as Spanish, French and Dutch, but also including Arabic and Hebrew. If the user downloads Microsoft Language Packs for certain languages, they too will be displayed. Punctuation marks may also be searched, which is a useful feature for finding all items which have been tagged, for instance, with a # notation.

A previous search may be modified by changing the search terms within the URL A search may be saved by adding an item to the Project and saving the Project as a *.qpf file.

The current invention can provide search results that are structured as opposed to a simple results list that is typically provided with Internet search engines. The search results are structured by URL and information. Search results may be returned in an outline tree form corresponding to the original tree structure that was searched. Thus, both the search and the search results are different based upon the starting tree structure of the search.

### EXAMPLE

### Data Resource and Data Management

The tool provides strong data management capabilities, and functions somewhat like a database. A database typically has more restrictions on data representation and data manipulation. The current tool enables a user to effectively organize, search, and manage information through the use of a multiple tree structure, the item representation by name-URL-description, and the search and preview capabilities. The combination of these properties—the tree structures, the data representation, and the search/preview capabilities provides a useful tool for data organization and data management.

### EXAMPLE

### Manipulating Lists

In this example lists such as customer content, internet indexing, or search results may be presented in a tabbed outline form and the resulting list may be manipulated.

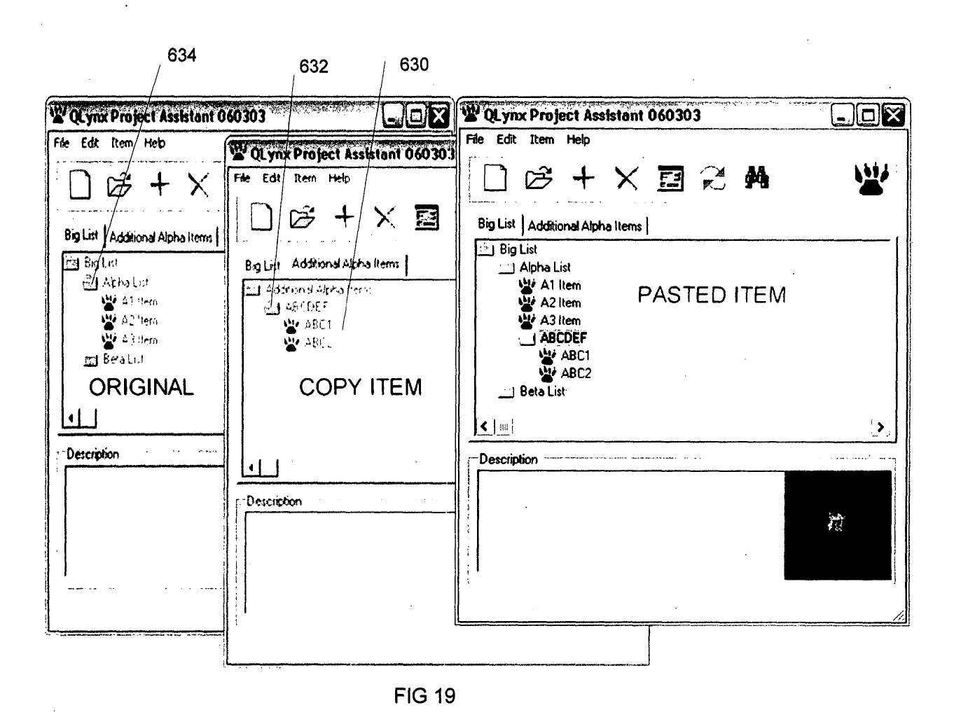

Referring now to FIG. 19, portions of folders and lists 630 may be copied and pasted between a first tab 632 and a second tab 634. The same operation may also be used inside the same tab to rearrange the Project, although the most typical use will be between tabs.

Key documents such as emails and faxes may be organized into folders, copied or moved to other folders, and accessed.

Drag and drop capabilities permit manual rearrangement of items and folders within a single project file.

### EXAMPLE

### Searching Lists to Create a New File

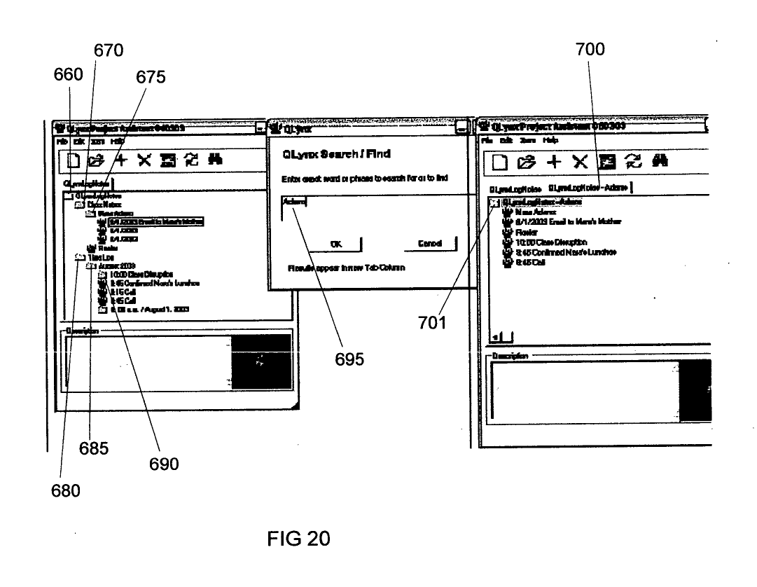

Referring now to FIG. 20, the search/find feature of QLynx does not just create a results list, but actually creates a separate QLynx Project File 700 which may then be saved and recalled as with other files. This feature permits wider use of searches than just the narrowing of a large list. In a large number of cases, searches will not be necessary because of the careful categorization of items in clearly recognizable items. Unlike some search features in prior art programs, QLynx searches on all characters within an item—Name, URL, and Description.

The search may be conducted at a desired level, and the results of the search may be portable as contrasted by a favorites folder in prior art which typically cannot be moved. The searching acts as the filtering of lists, and is complemented by the ability to create new lists for search results and combining lists.

In this example, a first outline of information is provided. In this first outline, all information is associated with a file, and there is a first high level file 660 which includes all information in the project. The user may select the high level directory 660, or any lower level file or directory such as directories 670, 675, 680, 685, or 690 and conduct a search, such as for a specific term. When the search is conducted, QLynx will create a new tab xx with a default name “QLynx-search term”. In this example, the search term “Adams” is used in the search field 695 as applied to an intermediate directory 670. The resulting tab will include a new high level tab 701 and could include lower level directories for those entries that contained the search term. Thus QLynx creates smaller lists from a large list. This filtering of the larger lists to smaller lists provides the ability to create a large number of additional project files, which can then be expanded as needed. Each of the smaller lists is fully functional, and may be further manipulated.

### EXAMPLE

### Combining Lists to Create a New File

In the previous example, a first outline of information is provided in the form of a first portion of a tree 670, such as shown in FIG. 20. The process may be reversed. The user may select all or a part of a second list 701 and add it to an existing list 660, thereby creating a large list from several smaller lists. Examples of this merging to a larger list include individual user creation of a working list from sources such as sponsor-developed content, content which may be purchased from QLynxnet Corporation, or from a website which might collect user-submitted files such as music and graphics collections.

### EXAMPLE

### Operating Tool

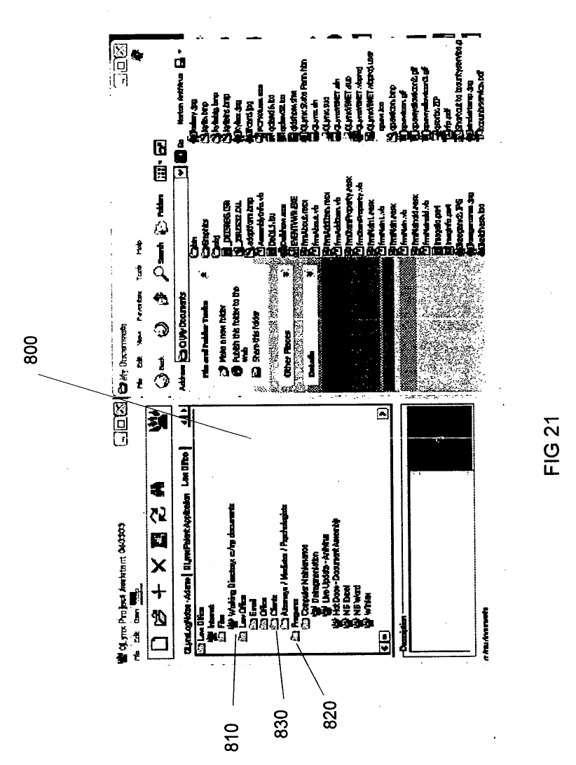

FIG. 21 is an example of a desktop management application. In this application, a single desktop 800 is presented so that a user can launch local application programs from a “programs” directory 820, manage local files from a local directory 810, and may directly access particular projects or clients 830.

The invention supports the efficient launching of programs and opening of files. QLynx can serve as a substitute for the traditional desktop in the Windows™ Environment. This structure is coupled with the ability to use QLynx for notes and other information gathering and display. All files with *.exe file types are launched, and files which have been associated by a file type will open in their native application. More importantly, the contents of the files can be displayed in the QLynx Description Pane without the necessity of either opening the file or launching the program.

### EXAMPLE

### Windows™ Manager

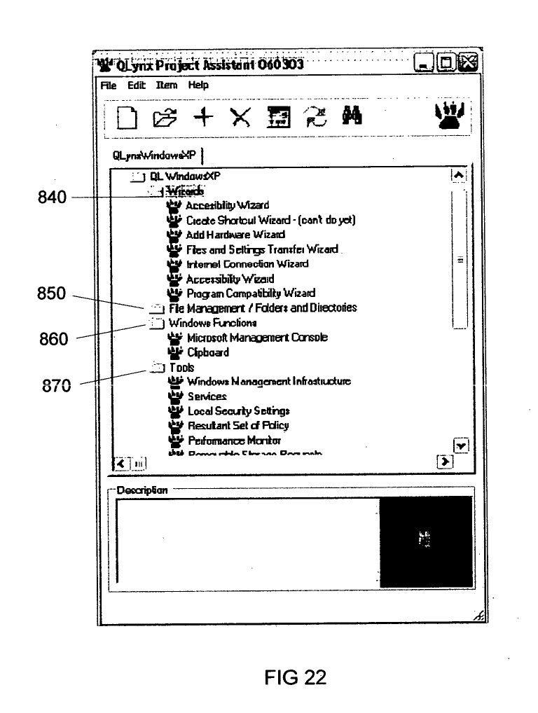

Referring now to FIG. 22, in this example, links are organized for a Windows XP™ operating system grouped by wizards 840, file management folders and directories 850, windows functions 860, tools 870 and control panel. The entries such as expanded under control panel by direct shortcut links to the appropriate programs. This representation and quick access to application programs is useful for both desktop computers and devices with smaller monitors such as notebook computers, tablet computers, and handheld devices.

In one embodiment, the invention supports multiple open windows, each having multiple tabs. Because QLynx is limited only by the user's resident memory, such as 256 MB, QLynx has only practical limits to Session Windows (individual launches of QLynx). In one embodiment, there is an arbitrarily defined 15-tab limit for each session. In practical terms, QLynx has displayed 2.5 million Internet Links with a 1.0 GB memory (970,000 with 256 MB); over 15,000 full texts of web pages, and the like. With smaller project files, the number of possibilities widens with no loss in speed. More than 150 full project files have been displayed at one time where 10 sessions each having 15 tabs is used.

In one embodiment, QLynx does not eliminate the need for a browser, it actually circumvents some of the messiness of the browser for its direct access to websites. That is, in prior art, the browser is typically launched with a default home page, and there will be at least some delay for the clutter caused by the default. QLynx eliminates the need for opening the browser—it merely launches a web page (*.htm) in its native application, which is the browser.

A partial list of Uniform resource locator (URL) types includes
file://
http://
mailto:
telnet: for research libraries
wais: wide are information services
news: news groups
ftp: file transfer protocol
   For example, in the current invention the mailto: URL opens the default Internet mail program and sends a message to the designated mail client. Specific telnet addresses may be provided to access libraries or specific content at a telnet site. The fax utility may be accessed directly in the send fax mode, cover page designer, or receive fax mode. The file transfer directly accesses the web site for transferring a file, and is faster than accessing an ftp program.

### EXAMPLE

### Sponsor Advertising

In one embodiment of the invention, a sponsoring organization such as a soft drink company makes available one or more types of project files for its potential customers. As the customers use the project files, the sponsoring organization's logo is present on the display screen. The sponsoring organization then has an advertising benefit to providing the tool and particular content to its target audience.

In addition to the option of always displaying one organization's logo, the tool may also be used by the organization to permit other organizations to display their logo. For instance, a sub-sponsor may desire that users see a separate logo such as Magazine Sponsor/Advertiser Sub-sponsor. The process is that if a file project name is the same as a graphic file, the splash screen will launch filename.qpf and filename.jpg.

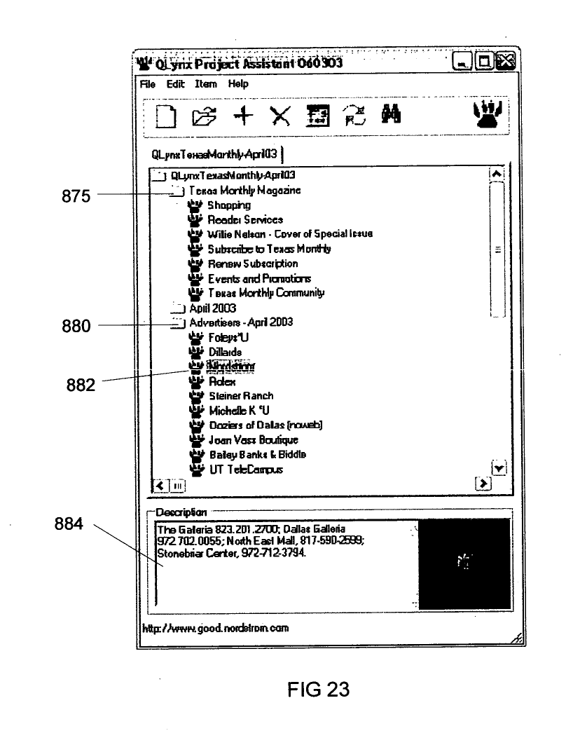

FIG. 23 is a publication example. A periodical publication such as Texas Monthly may provide content links 875 and advertising links 880. There is a link to each advertiser that has a web-page, or for the non-web-pages such as Nordstrom 882, there is a descriptive text in the descriptive block 884 including typically a phone number and an address.

These vendor links provide an e-commerce revenue source and represent a novel advertising medium. The listing of advertisers within the project files, and the ability to have separate project files permit the identification of very specific revenue gaining opportunities. In addition, the design features of the URL field permit “REDIRECTION” so that, if desired, a destination web link can identify the source of the links origin.

### EXAMPLE

### Teenager Application

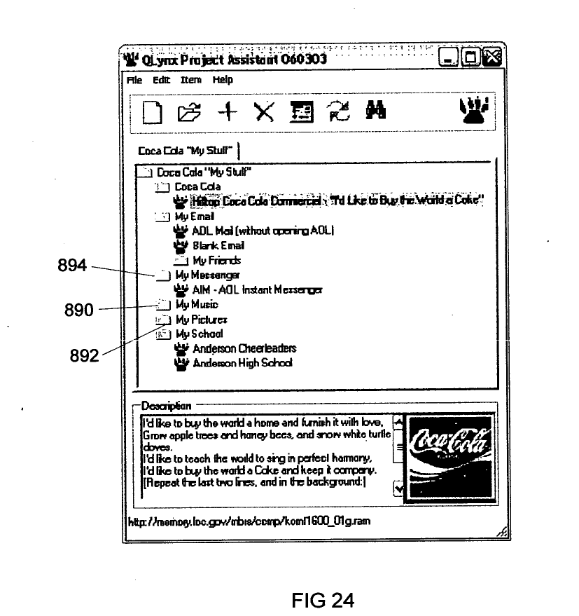

FIG. 24 shows another example which is directed at the teenager market. The files include music 890, pictures 892, and messenger items 894 such as AOL Instant Messenger™. The template permits a user to maintain and efficiently access that content which is of interest to the user. A sponsor such as a beverage company can display advertising on a tool that could be open most of the time during which users are on their computer.

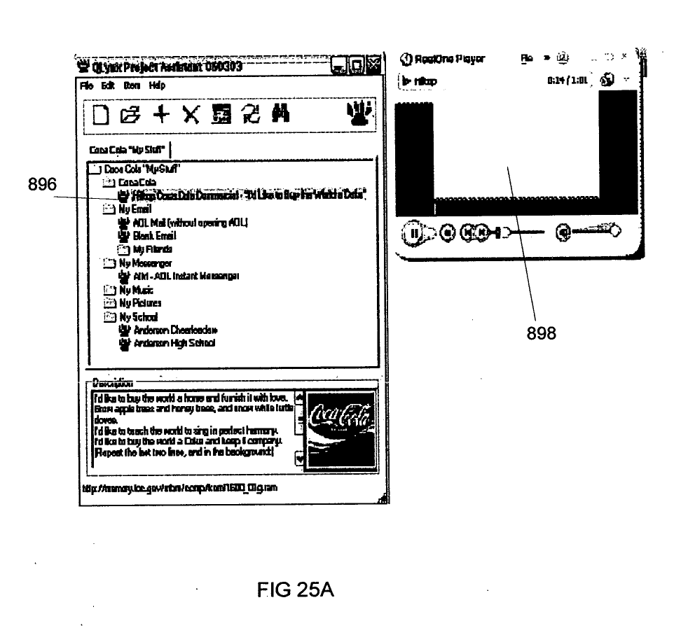

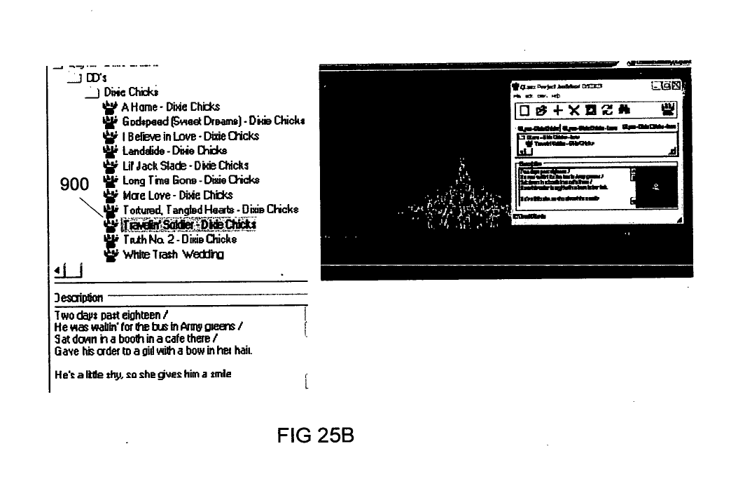

FIG. 25A is an example illustrating how QLynx may launch a video commercial. When the classic hilltop commercial 896 is selected, a video screen 898 is provided to play the video clip.

FIG. 25B shows an example of an audio CD 900 which may be launched from QLynx utilizing Windows Media Player™. QLynx may be used to catalog, search and launch the contents of Compact Discs. Many of the prior art devices do not permit searching, nor do they permit the same type of annotations as made possible by the description pane in QLynx.

### EXAMPLE

### Organization and Access of Music Files

In the previous example, a music library may be arranged with additional open Project Files depicting a range of entertainment value links and a filtered search on music lyric content. The description panes permit a large capacity of notes on such items, which may be searched as song name, Artist name, year, and the like.

For example, the detailed description may include the song lyrics, so that a search may be done on a few words from the song.

Open projects contain item listings to a variety of links to live television, live radio, live ski-cameras, and audio commercials.

FIG. 25B represents a lyric search for a song including “a bow”. The search provides the link, and the song, which includes a line about “a girl with a bow in her hair” can be launched. As also shown above, the search/find feature locates “bow” and creates a QPF named “MYPLAYLIST-bow.” The name “MYPLAYLIST” is, by default, the name of the Project, “bow” is the search term.

### EXAMPLE

### Foreign Language News

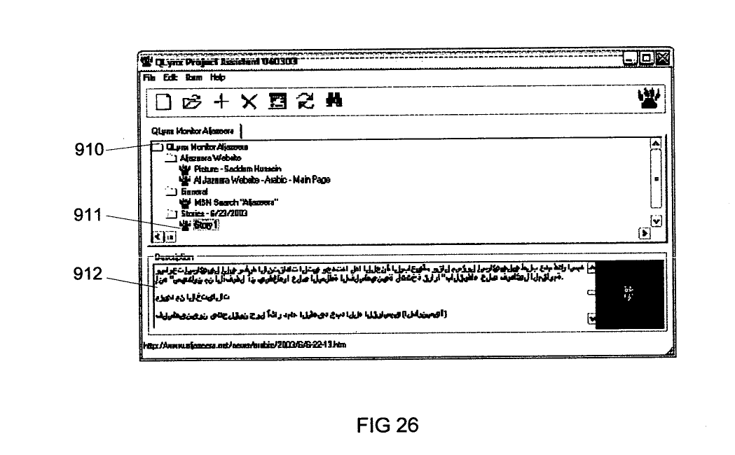

Referring now to FIG. 26 which is a sample page captured from the website of a foreign language cable news organization 910, the QLynx Project would include QLynx icons for web pages of interest as they are contained on the cable news organization website. In this example, the individual Web Pages are launched from the same common interface of a single Project File. The Description Pane 912 contains full text of a story 911 in the original foreign language, from where it can be quickly browsed for content of intelligence agency interest, without the necessity of actually accessing the site.

### EXAMPLE

### Association Content

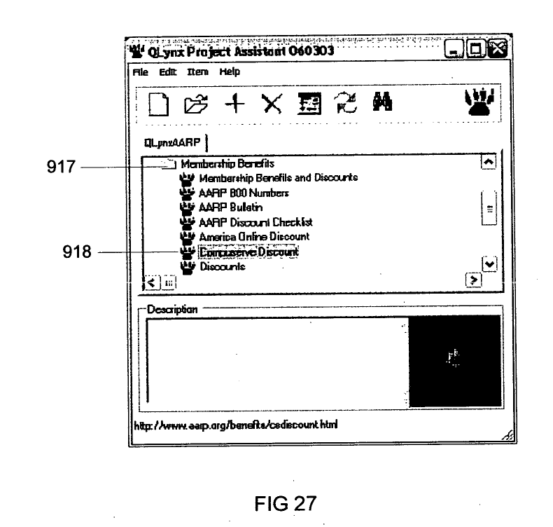

FIG. 27 is an example of an organizational application such as American Association for Retired Persons, AARP. In this case the project opens a direct link to particular web pages such as membership benefits 917 such as discounts 918. This is an example of the application opening both local and internet based programs. Service Provider links are directly accessed by the QLynx to providers such as auto insurance, investment, life insurance, etc. The example may also provide a direct link to email and applications such as word processing programs.

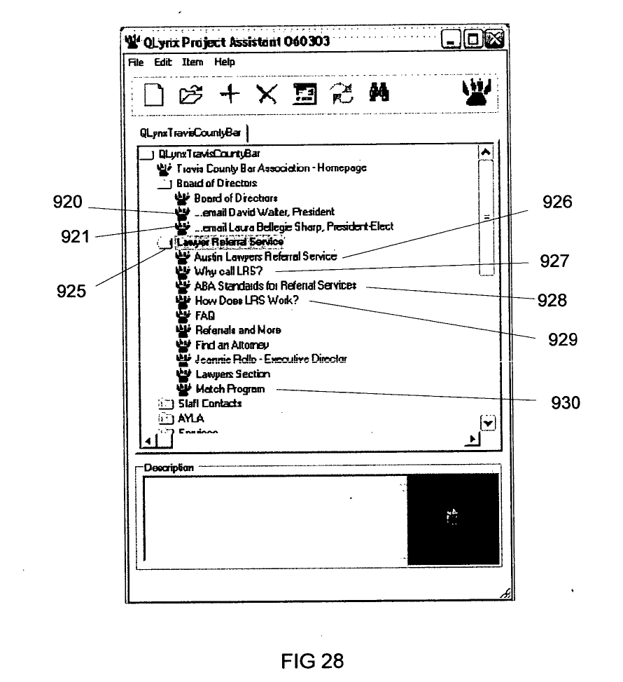

Referring now to FIG. 28, a local bar association maintains a QLynx application with information about the association including email addresses 920 and 921, and references to services 925 provided by the association. In this example, more detailed information about the services 926-930 can be seen when the service directory 925 is expanded. The user may then go directly to the page of interest rather than navigating through multiple web pages. This example also includes a variety of links to other pages of interest to association members.

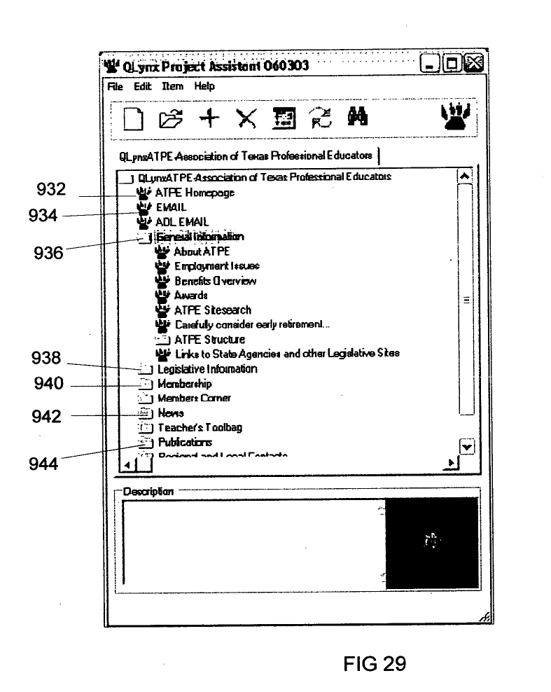

Referring now to FIG. 29, another association example is a Teachers Association including access to homepage 932, email 934, general information 936, legislative information 938, membership 940, news 942, publications 944, and various state and regional content.

### EXAMPLE

### Functional Content

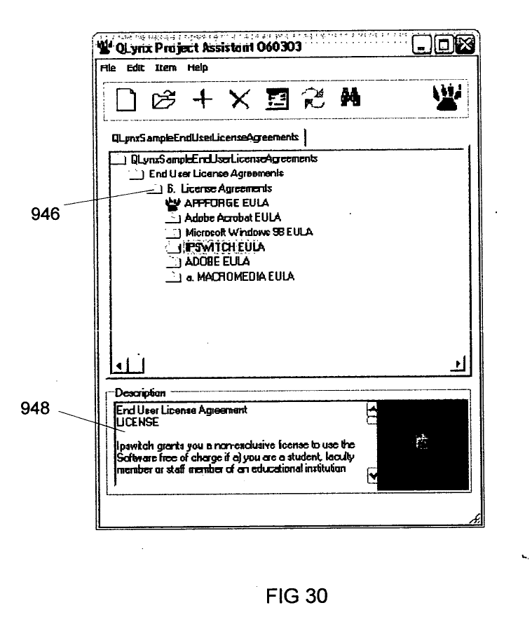

FIG. 30 shows an organization of several types of end user license agreements 946 including direct website access and descriptive materials 948 in the descriptive block of the QLynx main screen.

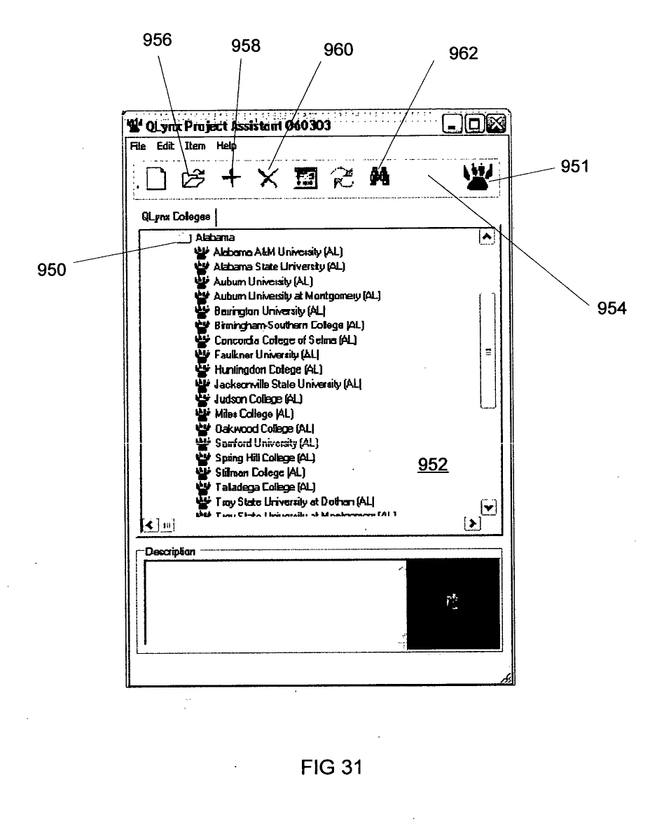

Referring now to FIG. 31 which is a partial listing of a large collection of the home pages of colleges and universities 950. The information contained in each item varies from email address to contact information and is the type which could be beneficially used by high school counselors, or consumers of various types. The project is an example of content development which may be collected for client sponsors who may desire to target that particular market audience. The graphics toolbar 954 provides icons for opening a file 956, filing a collection of links as a “.qpf” file; adding a link 958, deleting a link 960, and search 962. In this example, a QLynx icon 951 is presented near the upper right corner of the display 952. As described above, an organizational icon can be substituted for the QLynx icon. The organizational icon facilitates sponsorship of a QLynx collection by an entity. In this example the content includes college web sites, HTML or .PDF college application forms, word processing essays, one or more summary spreadsheet table, and other information. These different file types are organized and accessed under a common outline format so that the same selection process is used for a word processing file as for an internet web site link. In this example, college web sites may be arranged with specific access to admissions or other items.

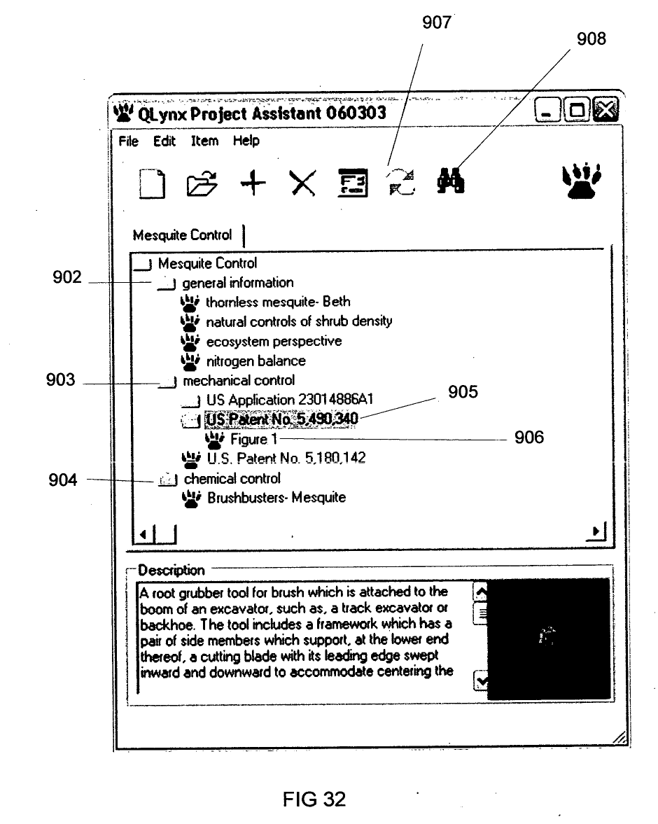

FIG. 32 is an example of a QLynx file structure for a patent search involving mesquite brush control. The project file includes folders for general information 902, mechanical control 903, and chemical control 904. The mechanical control folder includes folders for several patents or patent applications such as U.S. Pat. No. 5,490,340. When the folder 905 for this patent is opened, the abstract for the patent can be viewed in the description pane. Important portions of the patent may be saved as specific URL links as shown by the link to FIG. 1 906 so that particular pages or figures from a patent can be directly accessed from QLynx. The combination of the description and the links to specific pages permits rapid access and retrieval of key figures or other material in the patent without requiring the user to scroll through multiple pages. The tree structure organization of the links permits patents and other information to be arranged logically in the same structure. As additional material is discovered, it can be added at an appropriate location in the tree structure such as a new item, a new folder, or a new tab. The ability of QLynx to support and display as many as 20 levels of subfolders means that there are no practical limits to the extension of a concept to its smallest components. The ability of QLynx to search and find across levels means that there are new concepts which can be formed. It is possible to employ another descriptor for the QLynx capabilities in that a “taxonomic structure” or taxonomy may be formed for any possible project—QLynx does not create the taxonomy so much as it permits the creation. However, the organization, search, find and launch capacity provides the functional ability to complete the process of organizational thought.

The double green arrows 907 in the icon lines or the refresh command which takes the Q-Lynx file back to the last saved version. The find feature as indicated with binoculars 908 in the icon line searches the entire name, URL and description fields for a particular clause.

### EXAMPLE

### Real Estate

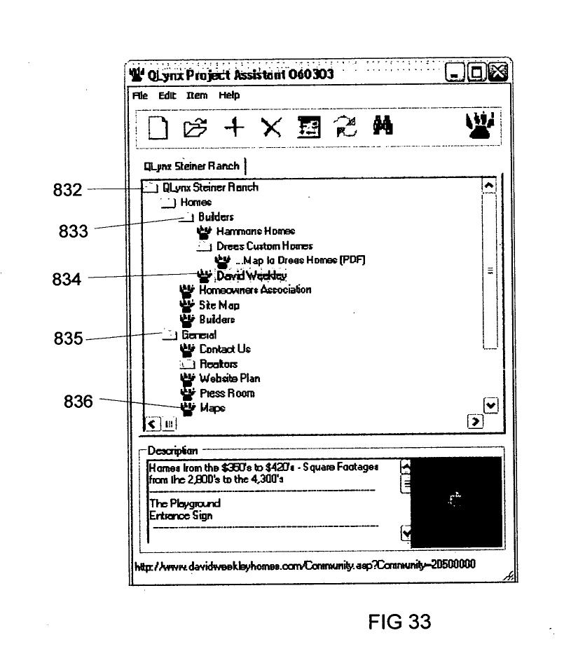

FIG. 33 shows a real estate example for a subdivision 832. Folders are provided for builders 833. When a particular builder 834 is selected, the description block provides information about the builder. A general information folder 835 includes a link to maps 836 and other resources.

### EXAMPLE

### Project Assistant

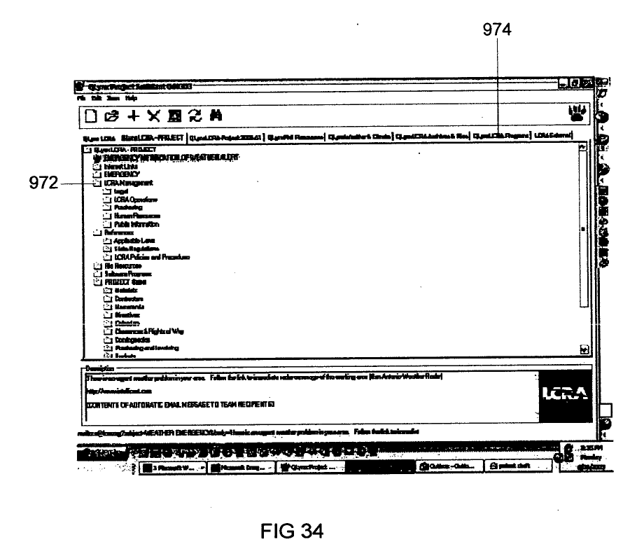

Referring now to FIG. 34, a full screen depiction is illustrated of the various kinds of additional tabbed resource panel which would be of interest for a governmental agency which could utilitize QLynx for a Project Management Software tool.

In this embodiment, the multiple links across project files include the ability to launch programs 972, preview and retrieve files 974, and utilize the main qpf file as a task organizer for management of a particular development project. The invention supports customer specific content. Because of its flexibility, and the organizational trees structure of folders and items, QLynx has been seen to be able to address virtually any project—thus, for instance, it was quickly modified to address “Project Management Concerns” for a governmental agency, whose software request essentially sought coordination of all programs, files, and internet links—what QLynx does.

One application of the invention is to use the structure of the sessions, tabs, and outlines of names, links, and descriptions to develop a project. For instance, the user may start with an outline of tabs and names within a session and use that outline to provide a rough scope of a project. As additional information is researched or developed, it can be summarized in the descriptive blocks and accessed through URL links to local or internet files. This project assistant capability is useful for organizing large amounts of information such as an internet research project, and incorporating the user's outline, initial drafts, etc, in a structured manner.

### EXAMPLE

### Teacher's Log File

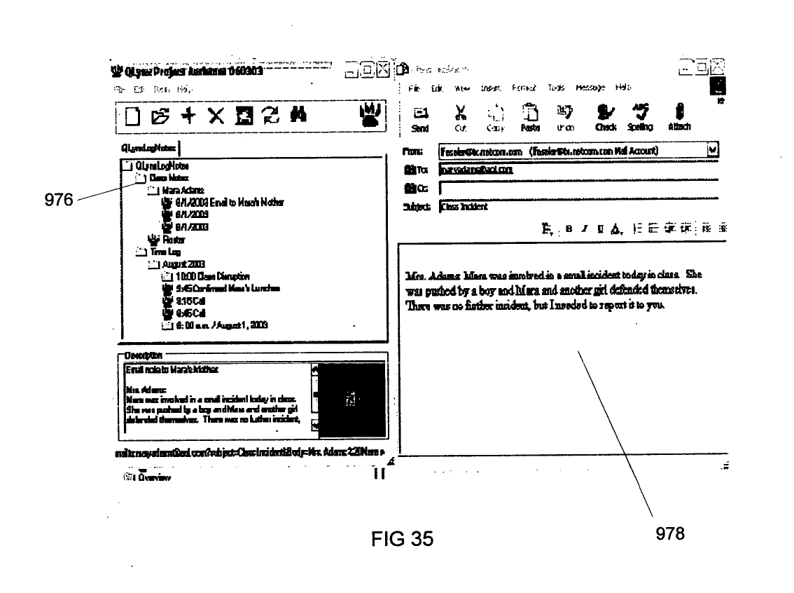

Referring now to FIG. 35, a Teacher's Organization can sponsor, as a member benefit, a LogFile project with which teachers can record notes 976 on progress, grades, disciplinary issues or other classroom events. Such a log file would be of use to receptionists, attorneys, psychologists, 911 operators, or other functions in which it is necessary and desirable to maintain chronological records of events. FIG. 35 also shows an example of an automatic email 978 which can be launched, completely filled in, by the teacher to a child's parents. In the example, the teacher was recording unfolding events in her classroom, when disruptive behavior occurred. Because it is helpful to have an automatic message to the parents, an item was created permitting the message to be sent, while the teacher continues on with the events or with other classroom occurrences.

### EXAMPLE

### Foreign Language Content

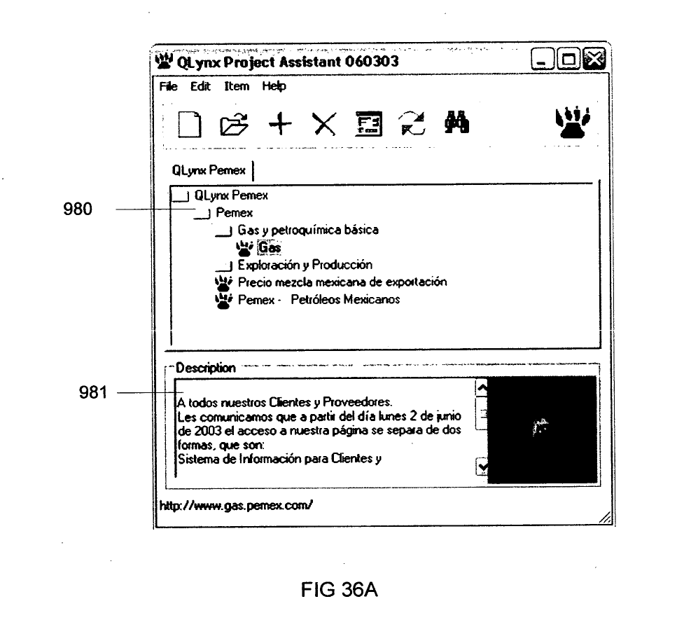

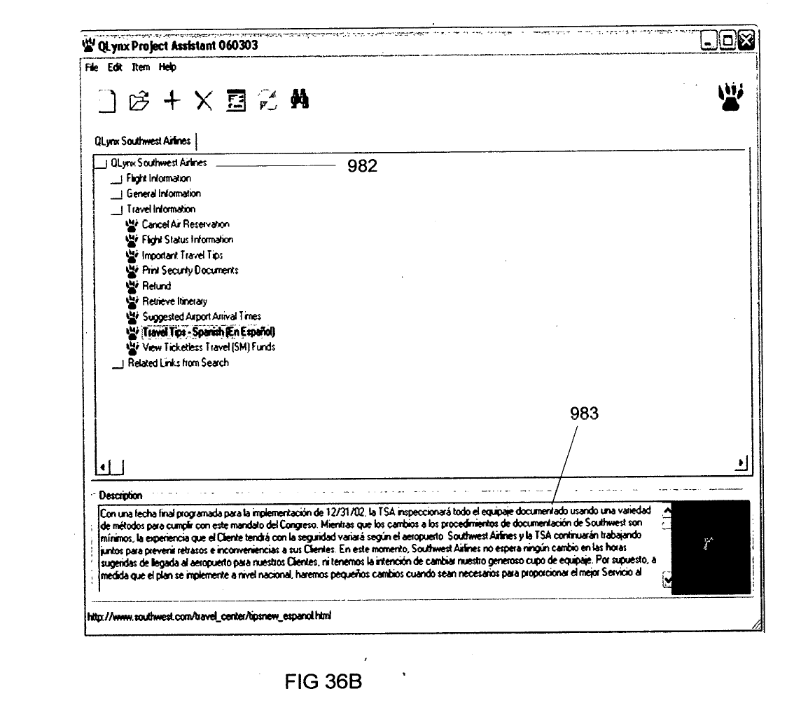

FIG. 36A illustrates the use of QLynx as a website sampler for the national petroleum company of Mexico 980 with Spanish language description 981. FIG. 36B illustrates the incorporation of foreign language content for an airline 982 showing information including travel tips 983. Each of the samples can be utilized as customer information advertisements for the sponsoring organization and are examples of the way in which QLynx can display and utilize the character sets required for foreign language uses.

### EXAMPLE

### Guide Content for City

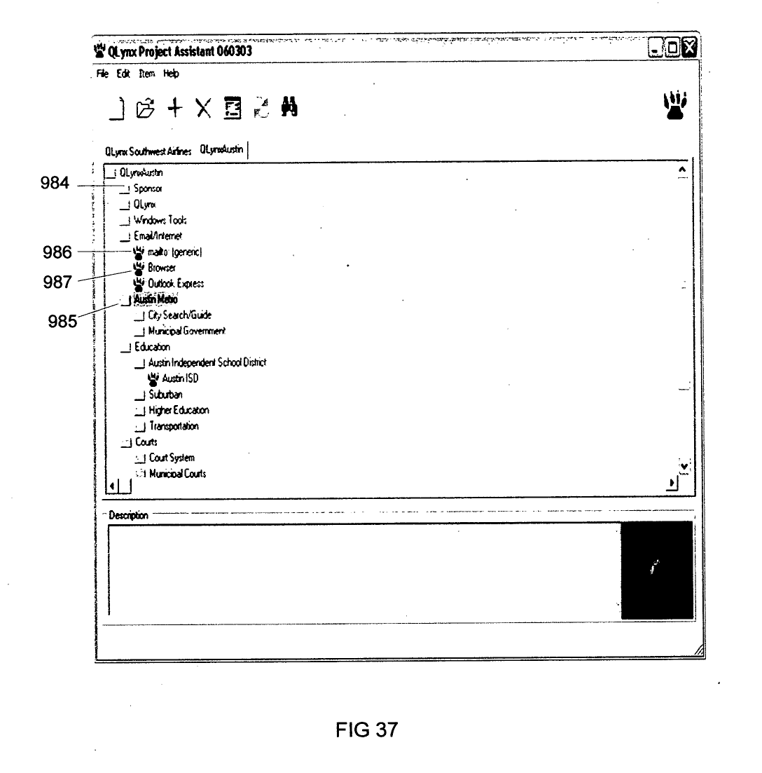

Referring now to FIG. 37, a generic guide for a particular area such as Austin Tex. can be organized by can be organized by showing a sponsor folder 984, area information 985, computer tools such as email 986 and internet access 987, information about a particular area broken down by the area education course, media, etc, specific access to particular television stations in the area.

Generic models have been created which can be expanded city by city, and would be of particular use to a broadly-based consumer sponsor such as one of the interstate banks or media companies such as the cable television providers or within the telecommunications industry.

### EXAMPLE

### Email Used to Warn Field Crews of Impending Weather Crisis

Utilizing the standard MAILTO function, QLynx has a basic ability to execute all outgoing emails by avoiding a series of delaying screens. That is, utilizing QLynx as one's address book offers a greater ability to speed email and to utilize its capabilities for descriptive notes and other matter.

QLynx can also dispatch email which may be complete as to Addressee, Copies, Subject and Body or for a combination of the items. QLynx also rapidly dispatches group emails to multiple recipients.

The example illustrates an emergency weather alert from the governmental management project shown in FIG. 34. The email provides an instant link to the nearest local weather radar.

### EXAMPLE

### Nested Folders

In this example, folders can be categorized to a level of at least 18 subfolders within a main topic. The ability to use a large number of subfolders permits efficient organization of information and links.

1. A method of presenting a plurality of URL links to a user of a display device, the method comprising
opening a session, the session having a plurality of project tabs;
displaying on the display device, at least a portion of the plurality of project tabs associated with the session, such that the user may select a tab;
determining which tab is selected by the user;
for the selected tab, displaying a tree structure comprising
at least one folder, such that the user may select and expand a folder, and
a plurality of names within the folder, such that at least a portion of each name is presented on the display, such that the user may select a name;
determining which name is selected by the user;
for the selected name, presenting
the name,
a URL link associated with the name, and
optional descriptive material associated with the name, such that the user may review the name and the descriptive material and decide whether to access the URL link.

2. The method of claim 1 further comprising
presenting a plurality of folders within the tree structure, such that the user may expand and contract the display of the folders.

3. The method of claim 1 further comprising
displaying an advertising logo in proximity to the tree structure.

4. The method of claim 1 wherein
a first name is associated with an Internet page; and
a second name is associated with a local file.

5. The method of claim 5 wherein
the local file is selected from the group consisting of spreadsheets, word processing files, data elements, and computer programs.

6. The method of claim 1 further comprising
for the selected name, presenting the name, a URL link associated with the name, optional descriptive material associated with the name, and a time stamp.

7. A method of organizing information associated with a plurality of URL links, the method comprising
associating a name of an item with each URL link,
establishing a tree structure of folders over a plurality of tabs, such that each tab contains at least one folder, and such that at least one tab includes a folder comprising at least one other folder;
for each name associated with a URL link,
determining the most appropriate existing folder for the name,
determining whether the existing folder is sufficiently descriptive for the name, and
if the existing folder is sufficiently descriptive for the name, then adding the name to the existing folder such that a user can access the URL associated with the name by selecting the name, and
if the existing folder is not sufficiently descriptive for the name, then adding a new folder to the tree and then adding the name to the new folder such that a user can access the URL associated with the name by selecting the name.

8. The method of organizing information of claim 7 further comprising
moving the name of an item from a first tab to a second tab.

9. The method of organizing information of claim 7 further comprising
moving the name of an item from a first folder to a second folder.

10. A method for an entity to present structured content to its members, the method comprising
providing a tabbed tree structure to the members, such that the tree structure comprises at least one session, each session comprising a plurality of tabs, each tab comprising an outline of folders including at least one folder, at least one folder comprising at least a portion of a name;
permitting the user to access the portion of the name, thereby displaying the complete name, a URL associated with the name, and a description associated with the URL;
permitting the user to select the portion of the name, thereby accessing the URL associated with the name.

11. The method of claim 10 further comprising
permitting the user may expand and contract the display of the folders.

12. The method of claim 10 further comprising
displaying an advertising logo in proximity to the tabbed tree structure.

13. The method of claim 10 further comprising
a first name associated with an Internet page; and
a second name associated with a local file.

14. The method of claim 13 wherein
the local file is selected from the group consisting of spreadsheets, word processing files, data elements, and computer programs.

15. The method of claim 10 further comprising
permitting the user to enter a search term and a folder;
filtering the contents of the folder; and
returning a new folder of search results, such that the new folder comprises each name where the search term occurs in the name, where the search term occurs in the URL associated with the name, and where the search term occurs in the description associated with the URL.

16. The method of claim 10 further comprising
permitting the user to modify the structured content.

17. The method of claim 16 further comprising
permitting the user to rename link descriptive titles.

18. The method of claim 16 further comprising
permitting the user to add and delete descriptive titles.

19. The method of claim 10 further comprising
displaying an association logo when the structured content screen is viewable.

20. The method of claim 10 further comprising
including a plurality of association web pages as links.

21. The method of claim 10 further comprising
including access to local files and application programs through links presented on an outline page.

22. The method of claim 10 further comprising
including access to email through links presented on an outline page.

23. A method of searching the content of a plurality of URL links, the method comprising
starting with a session comprising at least one tab, each tab comprising an outline of folders including at least one folder, at least one folder comprising at least a portion of a name;
selecting a folder;
entering a search term;
filtering the contents of the folder; and
returning a new project of search results, such that the new project comprises each name where the search term occurs in the name, where the search term occurs in the URL associated with the name, and where the search term occurs in the description associated with the URL.

24. The method of claim 23 further comprising
permitting the user to preview the content of a URL link by accessing a name associated with the URL link, thereby displaying the name, the URL, and a description associated with the URL; and
permitting the user to select the name, thereby accessing the URL.

25. An information management system comprising
a computer display device;
a local memory means for storing a first local file, such that the first local file can be accessed by a first URL; and
a tree structure display on the computer display device, such that the tree structure display comprises
at least one folder, and
a first name associated with the first URL,
such that when user of the computer display device views the first name, the first name, the first URL, and a description of the first URL are displayed on the display device, and such that when the user selects the first name, the first local file is accessed.

26. The information management system of claim 25 wherein the display device is a handheld computing device.

27. The information management system of claim 25 wherein the display device is a cell phone.

28. The information management system of claim 25 wherein the display device is a tablet computer.

29. The information management system of claim 25 wherein the display device is a notebook computer.

30. The information management system of claim 25 further comprising
an internet access means for accessing a second file by a second URL; and
a tree structure display on the computer display device, such that the tree structure display comprises
a name associated with the second URL,
such that when user views the second name, the second name, the second URL, and a description of the second URL are displayed on the display device, and such that when the user selects the second name, the second file is accessed.

31. A project assistant method comprising
identifying a plurality of tasks for an undertaking;
providing a descriptive name for each task;
providing a tree structure for organizing the descriptive names of each task;
placing the task names in the tree structure at a first stage of the undertaking;
for each task name, subsequently associating with the task name a URL address for content associated with the task and a description of the content at the URL address.

32. The method of claim 31 further comprising
associating a URL address with the task name at a different time than associating a description of the content at the URL address.

33. The method of claim 31 further comprising
opening an application for accessing a URL address, such that the application executes a task.

34. A method of presenting links to a plurality of music files, the method comprising
for each music file, storing, in a tree structure,
a name for the music file,
a URL for accessing the music file, and
descriptive material for the music file;
grouping the music files in the tree structure according to a first organizational criteria;
searching at least a portion of the tree structure according to a second search criteria;
displaying results of the searching;
previewing the results of the searching by displaying for a selected name, the name, the URL, and the descriptive material; and
accessing a URL associated with a selected name.

35. The method of claim 34 wherein
the descriptive material includes a recording date, an artist, and at least a portion of the lyrics of a song.

36. The method of claim 34 wherein
the descriptive material includes a portion of the music file.

37. The method of claim 34 wherein
the first organizational criteria is selected from the group consisting of recording date, alphabetical listing of artist, music type, and alphabetical listing of name.

38. The method of claim 34 wherein
the second search criteria is selected from the group consisting of a portion of the lyrics, a date, and an artist.

39. A method for an association to provide structured content to its members, the method comprising
presenting at least one link outline page, such that the link outline page presents a plurality of link folders, such that
at least a portion of the link folders are expandable by a member, such that when the link folder is expanded, the user may view the link contents of the folder, and
presenting the links for the folder names and the folder contents as descriptive titles;
presenting, upon the viewing of a descriptive title by a member, further descriptive material; and
accessing, upon selection of the descriptive title by a member, a URL associated with the descriptive title.

40. A functional advertising device comprising
a computer display device;
a local memory means for storing a first local file, such that the first local file can be accessed by a first URL;
a tree structure display on the computer display device, such that the tree structure display comprises
at least one folder, and
a first name associated with the first URL,
such that when user of the computer display device views the first name, the first name, the first URL, and a description of the first URL are displayed on the display device, and such that when the user selects the first name, the first local file is accessed; and
an advertising logo displayed on the computer display device.

41. A desktop manager device comprising
a computer display device;
a local memory means for storing
a first local file, such that the first local file can be accessed by a first URL,
a computer program, such that the computer program can be accessed by a second URL, and
an Internet web page, such that the Internet web page can be accessed by a third URL; and
a tree structure display on the computer display device, such that the tree structure display comprises
at least one folder,
a first name associated with the first URL,
a second name associated with the second URL, and
a third name associated with the third URL,
such that when user of the computer display device views one of the first name, the second name, and the third name, the name, the URL associated with the name, and a description of the URL are displayed on the display device, and such that when the user selects the first name, the first local file is accessed, and when the user selects the second name, the computer program is accessed, and when the user selects the third name, the Internet web page is accessed.

42. A method for providing an extensible display, the method comprising
providing a first directory tree structure at a first time, the directory tree structure comprising
a plurality of folders, such that each folder may contain at least one item, such that each item includes
a name,
a URL address, and
a description;
annotating at least a portion of the directory tree structure by adding material to at least one item description; and
searching the directory tree structure to produce a second directory tree structure of search results.

43. The method of claim 33 further comprising
modifying the first directory tree structure.
